(19) United States
(12) Patent Application Publication
(10) Pub. No.: US 2026/0226887 A1
(43) Pub. Date: Aug. 6, 2026

(54) Heat Engine

(71) Applicant: Invenco Engineering Industires LTD, London (GB)

(72) Inventor: Aamer Shaikh, London (GB)

(73) Assignee: Invenco Engineering Industries Ltd, London, GB (GB)

(21) Appl. No.: 19/150,557

(22) PCT Filed: Jan. 24, 2024
(86) PCT No.: PCT/GB2024/050186

§ 371 Date: Jul. 24, 2025

(30) Foreign Application Priority Data
Jan. 25, 2023 (GB) 2301080.4
Sep. 29, 2023 (GB) 2314995.8

(51) Int. Cl. F03G 7/06

(52) U.S. Cl. CPC F03G 7/063

(57) ABSTRACT

A gravity-heat engine 300 comprises a plurality of radial spokes 32 forming a wheel 30, each spoke 32 comprising a weighted piston 110a, a head of the piston being slidingly received within a piston chamber; and a working fluid 10 arranged to expand when heated. The gravity-heat engine 300 is arranged such that the weighted piston 110 is caused to move along the radial spoke 32 in a first direction in response to heating of the working fluid 10. The force may be transferred indirectly, by use of an intermediate hydraulic fluid 20.

The invention relates to a combined heat engine and gravity engine, which may be referred to as a gravity-heat engine, which uses both gravity and heating and cooling cycles to generate motive force. This motive force may optionally be converted into electricity. The gravity-heat engine is based on principles of the Carnot cycle, using the heating and cooling of a working fluid, and also uses the moment under gravity of weights moved by the fluid, to generate the motive force.

The invention relates to a new gravity-heat engine using the basis of the Carnot cycle, in contrast to conventional heat engines which generally use the energy generation methods of Rankine Cycle and Organic Rankine Cycle. Heating and cooling of a fluid are used to generate motive force, rather than using a pump to compress a working fluid as is done in most heat engines. The engine combines principles of the Carnot cycle with the use of gravity to assist in driving rotation of a wheel. It will be appreciated that the gravity-heat engines described herein are examples of heat engines, and may be referred to as heat engines for brevity.

According to a first aspect of the invention, there is provided a gravity-heat engine comprising:
a plurality of radial spokes forming a wheel, each spoke comprising a weighted piston; and
a working fluid arranged to expand when heated.

At least a head of the piston is slidingly received within a piston chamber.

The gravity-heat engine is arranged such that the weighted piston is caused to move along the radial spoke in a first direction in response to heating of the working fluid. The piston may form part of a drivetrain arranged to be moved—directly or indirectly—by expansion of the working fluid.

In embodiments in which the force transfer is indirect, a hydraulic fluid may be used as an intermediary between the working fluid and the piston.

For example, the gravity-heat engine may comprise:
a plurality of radial spokes forming a wheel, each spoke comprising a weighted piston, a head of the piston being slidingly received within a piston chamber;
a working fluid arranged to expand when heated; and
a hydraulic fluid located within the piston chamber and separated from the working fluid,
   and wherein the gravity-heat engine is arranged such that the hydraulic fluid is moved by the expansion of the separate working fluid so as to cause the weighted piston to move along the radial spoke in a first direction in response to heating of the working fluid.

The gravity-heat engine may further comprise a drivetrain arranged to be moved by the hydraulic fluid. The hydraulic fluid may therefore act as a force transfer intermediary between the working fluid and the drivetrain. The piston may form part of such a drivetrain.

A rapid cooling/heating process may therefore be used to generate mechanical energy, based on the underlying principles of the Carnot cycle.

The engine is scalable, from a small wheel for domestic applications to large-scale use in power generation and heat recovery. A heat and gravity power generation engine/system as described herein may be arranged to produce powers ranging from a few kilowatts to hundreds of megawatts.

The piston of each radial spoke may be independent of the pistons of every other radial spoke, in that their motion is not coupled.

The gravity-heat engine comprises a plurality of radial spokes forming a wheel—each spoke extending from a hub of the wheel to the wheel's rim and having a length at least substantially equal to the wheel's radius. Each spoke may comprise a weighted piston slidingly received within a chamber (it will be appreciated that the piston may extend beyond the chamber—at least a front surface of a piston head may remain within the piston chamber throughout its range of movement). Each piston is arranged to be moveable only along the respective radius of the wheel. No piston can pass through or across the hub.

The working fluid may be located (at least partially) within the piston chamber, and may be arranged to cause the piston to move along the radial spoke in the first direction (i.e. radially inward or radially outward, depending on the arrangement selected) when the working fluid expands in response to being heated. In such embodiments, there may be no need for a separate hydraulic fluid as described below.

Alternatively, the gravity-heat engine may further comprise a hydraulic fluid located (at least partially) within the piston chamber and separated from the working fluid. The hydraulic fluid may be arranged to be moved by the expansion of the separate working fluid so as to cause the piston to move along the radial spoke in the first direction (i.e. radially inward or radially outward, depending on the arrangement selected) when the working fluid expands in response to being heated. In embodiments with a hydraulic fluid, the hydraulic fluid is arranged to cause the piston to move along the radial spoke when the working fluid changes in volume. The hydraulic fluid in such embodiments is arranged to cause the piston to move along the radial spoke in a first direction when the working fluid expands and to allow the piston to move along the radial spoke in a second direction opposite to the first direction when the working fluid contracts. For example, the hydraulic fluid may be located within the piston chamber and arranged to cause the piston to move outwardly along the radial spoke when the working fluid expands and then allow it to move inwardly along the radial spoke when the working fluid contracts, or vice versa.

In such embodiments, the working fluid may be contained within an expansion chamber comprising a separator arranged to separate the working fluid from the hydraulic fluid. The expansion chamber may be arranged adjacent and parallel to the piston chamber. The expansion chamber and piston chamber may be connected such that hydraulic fluid can flow from one chamber to the other but the working fluid is retained within the expansion chamber. The working fluid may therefore be isolated from the rest of the drivetrain, potentially protecting the drivetrain from a corrosive or otherwise dangerous working fluid.

The working fluid may therefore be separated from the hydraulic fluid by a separator, which may take any suitable form. The separator may be a diaphragm separator, a bellows separator, or U-bend separator (e.g. mercury-filled). The separator may be arranged to prevent the working fluid from reaching the piston, and/or any other part of the drivetrain, but to allow pressure to be applied to the hydraulic fluid by the working fluid so as to drive the drivetrain, so transferring force. The drivetrain may therefore be isolated and protected from the working fluid, which may be corrosive.

Any suitable hydraulic fluid known in the art may be used. Preferably, a non-toxic and non-corrosive liquid is chosen, generally with a boiling point higher than that of the working fluid. The hydraulic fluid may have a relative density of between 1 and 3.

The working fluid may be contained within at least one expansion chamber. The or each expansion chamber may comprise at least one channel or passageway therewithin, the or each internal channel or passageway being arranged to allow a coolant to pass therethrough whilst the coolant remains isolated from the working fluid. The or each expansion chamber may comprise a central channel or passageway arranged to allow a coolant to pass therethrough whilst remaining isolated from the working fluid.

The piston chamber may be arranged such that the weighted piston moves inwardly along the radial spoke (i.e. towards a hub of the wheel) in response to heating of the working fluid. At least one of the working fluid and the hydraulic fluid (where present) may be located between the piston and an outer/circumferential edge of the wheel.

The working fluid may have a boiling point of less than or equal to 60° C. at standard pressure and/or a relative density greater than 1.

Using the properties of such a working fluid, implementations of the invention may demonstrate low heat energy being converted to useable mechanical energy/movement. This mechanical energy in turn can be used to rotate and power a turbine/generator for various different energy outputs, and/or to drive a pump or other mechanical system.

Due to the properties of the working fluid, this engine can be implemented in efficient power generation and heat recovery for low-temperature heat sources (e.g. from 60° C. up to 300° C. or 400° C., and optionally in the range 70° C.-400° C., 70° C.-150 ° C., or even 70° C.-100 ° C., or 40-60° C. in some scenarios), with no need to generate steam, so facilitating use of low-grade waste heat from various industrial processes and improving sustainability. Such low heat is one of the most abundantly available sources of energy—it can be renewable, sustainable, and can even be generated from landfill waste or animal waste. Use of waste heat from industrial processes may also improve efficiency and reduce electricity usage of large manufacturing companies and similar.

A separate hydraulic fluid may be used to transfer the movement between the working fluid and components of a drivetrain, so allowing the drivetrain to be separated and protected from the working fluid, which may be volatile, toxic, and/or corrosive, for example. The use of a separate hydraulic fluid may improve safety, so allowing use of fluids which would not normally be considered as working fluids.

The engine may cycle the specialised working fluid between two temperatures, causing the fluid to expand as it is heated and contract as it is cooled, so doing work on a piston (or other mechanical structure in a drivetrain of the heat engine). The engine may cycle the fluid between a heat source and a source of cooling so as to provide continuous generation of useful energy from available heat.

The working fluid may have a boiling point of less than or equal to 45° C. or 40° C. at standard pressure. In general, in operation the temperature of the working fluid may be maintained above ambient temperature throughout the cycle, for example being above 40° C. even in the cooling phase of the cycle. The relatively low boiling point may allow the working fluid to reach its boiling point and (at least partially) change phase from a liquid to a gas when heated in use in the heat engine, so providing a large expansion in volume, even when the temperature change of the working fluid above ambient is relatively small (e.g. only +20° C., 30 ° C. or 40° C.). The working fluid may at least partially condense again when cooled in use in the heat engine. It will be appreciated that, under pressure within an expansion chamber in use, the boiling point of the working fluid will be greater than that at standard pressure so the working fluid may only partially evaporate even at working temperatures significantly higher than its boiling point at standard pressure, e.g. working temperatures of around 100-120° C.

In use, pressures of the working fluid may be around 2,500 psi (around 17 MPa).

The working fluid may have a relative density of greater than or equal to 1.1, 1.2, or 1.3. A relatively high density (and therefore relatively low specific volume, as compared to many organic liquids) may improve the heat transfer rate and allow heat engine components such as pipes to be smaller than otherwise. The relative density is assessed for the liquid phase.

The working fluid may have a specific heat capacity of less than or equal to 3.5, 3, 2.5, 2, or 1.5 J/(kg ° C.). Optionally, the working fluid may have a specific heat capacity of less than or equal to 1.2 J/(kg ° C.). The relatively low specific heat capacity may facilitate more rapid temperature changes on exposure to a heat source or source of cooling, so hastening volume changes.

The working fluid may be at least 90% dichloromethane by volume, and optionally at least 95% dichloromethane by volume. The working fluid may be dichloromethane.

The working fluid may be chambered in specialised heating/cooling structures to facilitate the work done by the working fluid.

Each spoke may further comprise a heat exchanger comprising:
a broad surface forming a portion of an edge of the wheel (in particular, the surface having a significantly larger extent in either dimension perpendicular to the radial direction than in the radial direction); and
one or more passageways arranged to have the working fluid pass therethrough in use.

Due to taking the form of a thin/substantially planar structure at the end of a radial spoke in some implementations, the heat exchangers may be referred to as heat exchange paddles.

In some embodiments, a non-rotating rim or shield may be provided around the outside of the wheel, beyond the edge formed by the heat exchangers. The edge formed by the heat exchangers may therefore be the outermost part of the rotating part of the apparatus, but not the outermost part of the apparatus as a whole.

Each heat exchanger may further comprise one or more passageways arranged to have a coolant pass therethrough in use. The coolant passageways may be within the working fluid passageways (e.g. being in the form of concentric pipes), which may improve heat transfer efficiency.

The working fluid passageways may be enclosed in a heat-accumulation layer which stores heat. Coolant passageways within the working fluid passageways may be particularly beneficial in such embodiments, effectively bypassing the insulation when cooling is desired.

For example, the gravity-heat engine may comprise:
a plurality of radial spokes forming a wheel, each spoke comprising a weighted piston, a head of the piston being slidingly received within a piston chamber; and
a working fluid arranged to expand when heated,
   and wherein the gravity-heat engine is arranged such that the weighted piston is caused to move along the radial spoke in a first direction in response to heating of the working fluid; and wherein the working fluid is contained within at least one expansion chamber, the or each expansion chamber comprising a channel/passageway therewithin arranged to allow a coolant to pass therethrough whilst remaining isolated from the working fluid.

The gravity-heat engine may further comprise a coolant reservoir located above one side of the wheel and arranged to provide a flow of coolant to cool one side of the wheel. The coolant may be arranged to flow over the cooled portion of the wheel in some embodiments, and may be arranged to flow within heat exchange passageways in alternative or additional embodiments (for example in embodiments with openings on outer surfaces of the heat exchange paddles, the openings leading to coolant channels). The coolant may be water.

Each spoke may further comprise a pneumatic accumulator. The pneumatic accumulator may be arranged to store pressure and to work against the piston so as to move the piston in a second radial direction opposite to the first direction when the working fluid contracts in response to being cooled. The accumulator may therefore serve to return the piston to its original position once the piston/the spoke comprising that piston leaves the heated region of the wheel. The pneumatic accumulator may be located at or near a hub of the wheel when the working or hydraulic fluid is between the piston head and the rim, or at or near a rim of the wheel when the working or hydraulic fluid is between the piston head and the hub. The pneumatic accumulator may be located at an inner end of the spoke.

Each heat exchanger may be made of metal.

Each piston may be independent of every other piston, such that each piston can move independently of every other piston.

Each piston may be arranged such that it can move along a distance of no more than 90% of the radial extent of its spoke. As used herein, “radial extent” means the distance along a radial direction between the centre/rotation axis of the wheel and an outer edge of the wheel. The total wheel diameter would therefore be twice the total radial extent of a spoke.

Each weighted piston may comprise a weight of a relative density of greater than or equal to 3, and optionally of at least 7, the weight being arranged to move when the piston head moves. The weight may form all or part of the piston head in some embodiments. A smallest dimension of the weight may be parallel to the radius of the wheel such that the mass of the weight is radially localised.

The wheel may comprise a hub from which each spoke extends, the hub defining an innermost position that the head of each piston can reach.

The hub may comprise an independent locking mechanism actuator for each spoke. Each spoke may correspondingly comprise its own locking mechanism, arranged to be actuated by the actuator in the hub. The locking mechanism actuator may be arranged to trigger locking or release of a locking mechanism arranged to control movement of the piston, for example so as to lock the weighted head in place or release it, or to control in which direction along the radial spoke the piston is able to move. The locking mechanism actuator may be or comprise a pneumatic accumulator. The locking mechanism actuator may be or comprise a lever moved by contact with the piston head.

A kit of parts for assembling such a gravity-heat engine may also be provided.

According to a second aspect of the invention, there is provided a method of operating a gravity-heat engine as described in the preceding aspect, the method comprising:
orienting the wheel in a vertical plane; and
exposing one portion of the wheel to a heat source so as to drive rotation of the wheel by causing the working fluid in the radial spokes located within that portion to expand, moving the weighted pistons and so driving rotation of the wheel under gravity.

Radial spokes may therefore be rotated into, through, and out of the heated portion of the wheel. It will be appreciated that the contribution of the unheated portion of the wheel is also necessary to maintaining the rotation—as a given spoke cools, the working fluid for that spoke contracts, allowing the piston to move back to its original position. The weighted pistons therefore move inwardly and outwardly along the radial spokes in response to the temperature changes, altering the weight distribution of the wheel and hence providing a continual net moment in the selected rotation direction. The movement of weights radially along spokes creates a net moment which keeps the wheel rotating in use.

The unheated portion of the wheel may be actively cooled—e.g. by a coolant flow—in some embodiments. In embodiments with a coolant flow provided by a coolant reservoir located above the wheel, for example, the coolant flow itself may further assist the wheel's rotation, so providing a dual benefit.

The heat source may be located below one half of the wheel, such that one half-disk of the wheel of semi-circular surface area is heated by the rising heat. The heat source may be waste heat from an industrial process, or burning waste. As even low-grade heat may be used for various gravity-heat engines of the present invention, even fuel with a low calorific value may be used.

The method may further comprise one or more of:
(i) connecting an axis of the wheel of the heat engine to a generator so as to generate electricity in use; and
(ii) connecting an axis of the wheel of the heat engine to a mechanical drivetrain, so as to do mechanical work (e.g. operating a pump).

A source of cooling may be provided, optionally in the form of a flow of liquid (e.g. water). The cooling source may be located above one half of the wheel (the unheated portion), such that one half-disk of the wheel is cooled by coolant flowing downwards under gravity.

The method may further comprise causing a coolant to flow so as to hasten cooling and contraction of the working fluid in the radial spokes located within the unheated portion of the wheel (i.e. the portion of the wheel not exposed to the heat source). The coolant may be caused to flow through one or more passageways within the gravity-heat engine. The coolant may be water.

A method of operating a gravity-heat engine as described herein may therefore comprise:
obtaining a gravity-heat engine comprising a plurality of radial spokes forming a wheel, each spoke comprising a weighted piston slidingly received by a piston chamber and a working fluid arranged to expand when heated, wherein the gravity-heat engine is arranged such that the weighted piston is caused to move along the radial spoke in a first direction (i.e. radially inward or radially outward, depending on the configuration of the engine) in response to heating of the working fluid;
orienting the wheel in a vertical plane (such that its axis of rotation is horizontal);
exposing one portion of the wheel, in the form of a half-disk (separated from the rest of the wheel by a hypothetical vertical line), to a heat source so as to drive rotation of the wheel by causing the working fluid in the radial spokes located within the heated half-disk to expand, pushing the weighted pistons radially and so driving rotation of the wheel under gravity due to the net moment created.

In embodiments in which expansion of the working fluid is arranged to cause the piston to move inwardly (i.e. in which the first direction is radially inward), the engine may be arranged such that each spoke enters the heated half-disk near the bottom of the wheel, and the working fluid pushes the weighted pistons near the bottom of the heated half-disk inward, reducing their moment as compared to that in the unheated half-disk, so driving rotation of the wheel under gravity due to the net moment created. Radial spokes may therefore be rotated from one half-disk to the other—into, through, and out of the heated portion of the wheel.

The weighted piston may be partially or completely located within the piston chamber

The method may further comprise connecting an axle of the wheel of the gravity-heat engine to a generator or mechanical drivetrain.

Heat engines, including gravity-heat engines, as described herein may use principles of the most efficient thermodynamic cycle—the Carnot Cycle—in a way which has not been achieved for practical power generation previously.

Utilisation of low heat, and also gravity, allows the system to be set up anywhere, at any size, without having to use specialised a fuel, or requiring regular maintenance. The scalability of the engines also allows much greater flexibility in size than for current power generation models. Bearing in mind the limited facilities and infrastructure available in areas of some third-world and developing countries, this system has been designed to operate without a need for sophisticated facilities to manufacture and run the power generation engine. Engines as described herein therefore offer a ground-breaking system which can utilised as water pumps in rural agricultural areas, for example, without a need for mains electricity, for example using renewable fuels and waste products such as crops/crop waste and animal waste. Such engines may be used to provide mechanical work directly, e.g. to power a pump or move another drivetrain, without requiring an intermediate electricity generation step. Some efficiency losses can therefore be avoided.

There now follows by way of example only a detailed description of embodiments of the present invention with reference to the accompanying drawings in which:

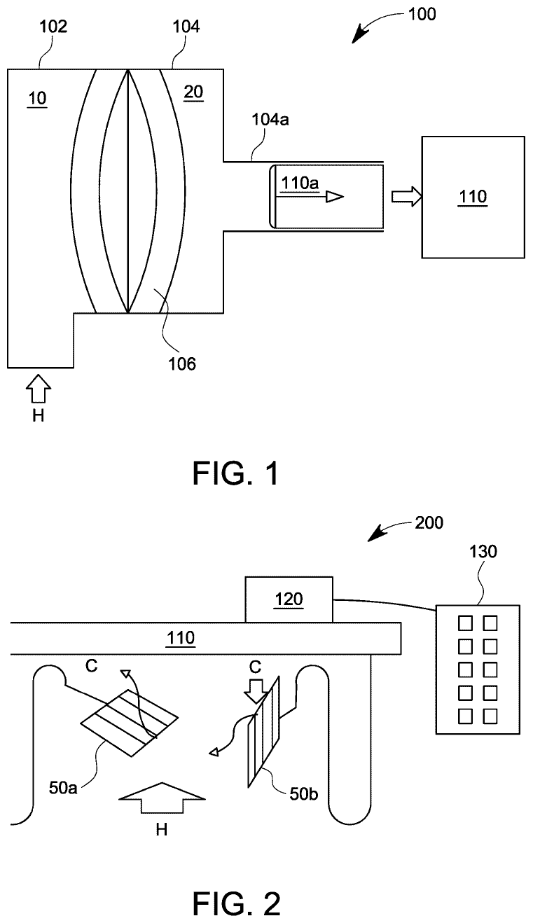

FIG. 1 shows a portion of a heat engine using both a working fluid and a separate hydraulic fluid, with a diaphragm separator between the two fluids;

FIG. 2 shows use of a heat engine to generate electricity, illustrating principles used in various embodiments of the invention;

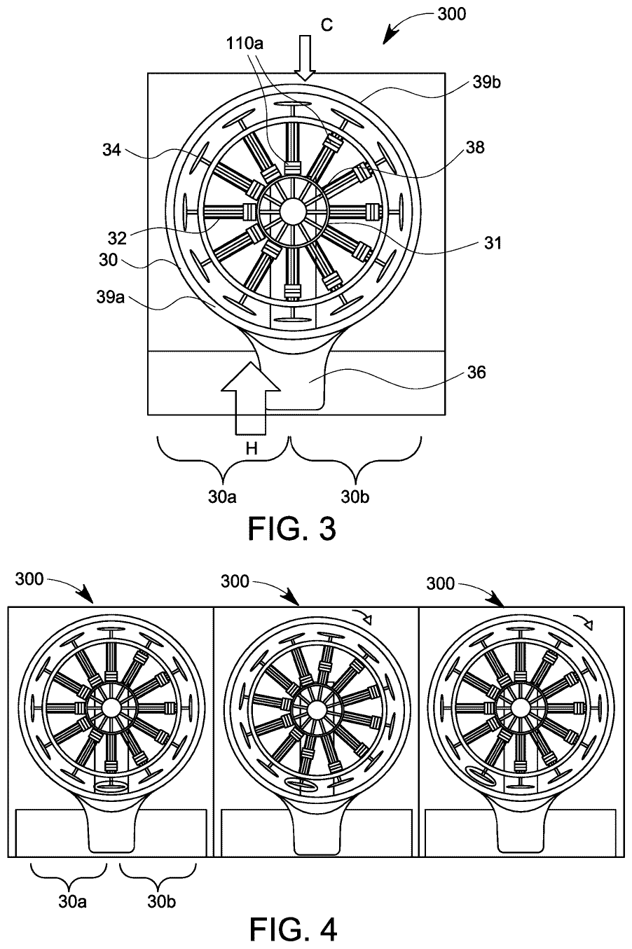

FIG. 3 shows a gravity-heat engine of an embodiment of the invention, having the general form of a wheel;

FIG. 4 shows the gravity-heat engine of FIG. 3 in different rotational positions;

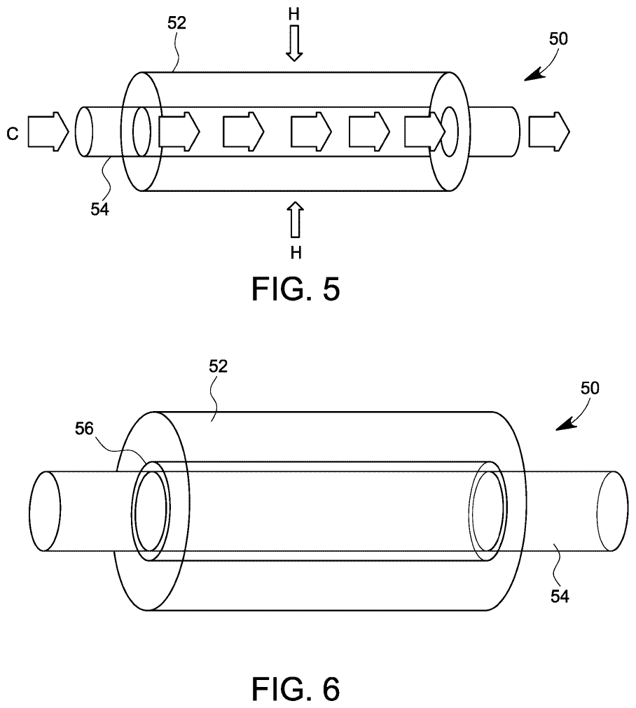

FIG. 5 shows a perspective view of a portion of a heat exchanger;

FIG. 6 shows the heat exchanger of FIG. 5, showing the working fluid expansion chamber surrounded by a thick-walled body and with an inner central coolant channel;

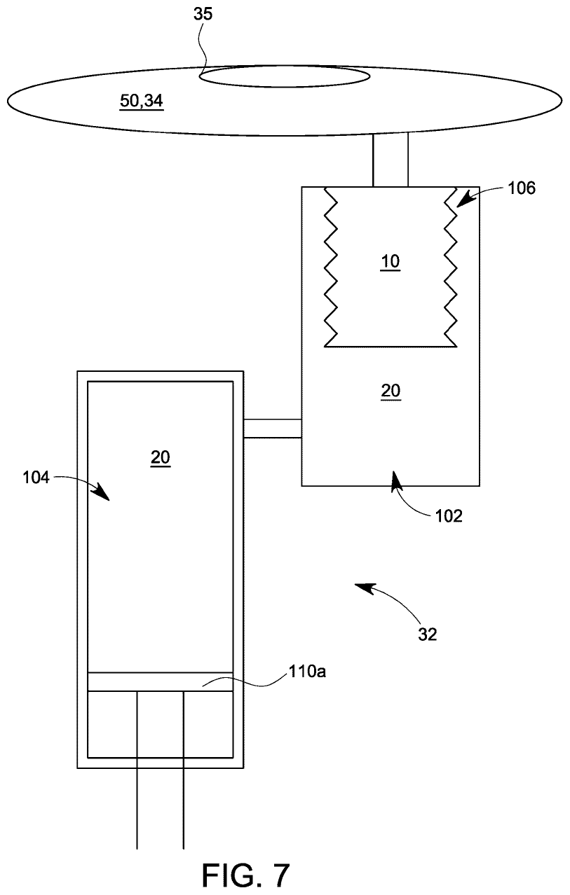

FIG. 7 shows an axial cross-section of a part of a spoke of the engine of FIG. 3, with a bellow diaphragm separator between the working fluid and hydraulic fluid;

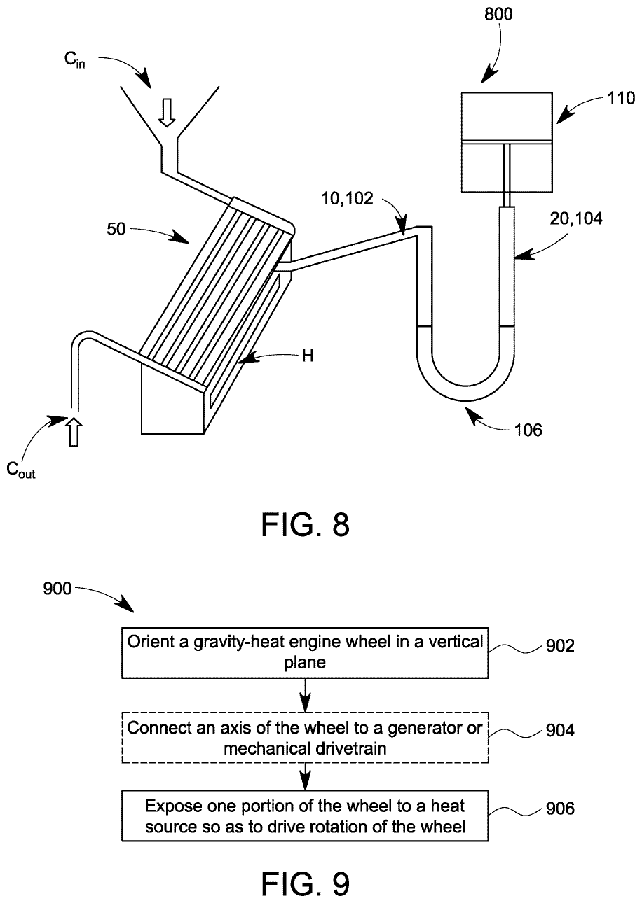

FIG. 8 shows an alternative heat exchanger design, illustrating principles used in various embodiments of the invention, with a mercury-filled U-shaped separator instead of a diaphragm separator;

FIG. 9 illustrates a method of an embodiment of the invention, using a heat engine as shown in FIGS. 3 and 4;

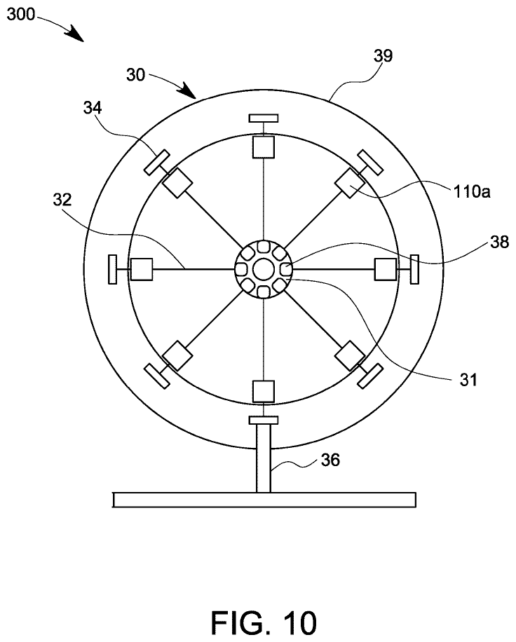

FIG. 10 shows a second gravity-heat engine having the general form of a wheel;

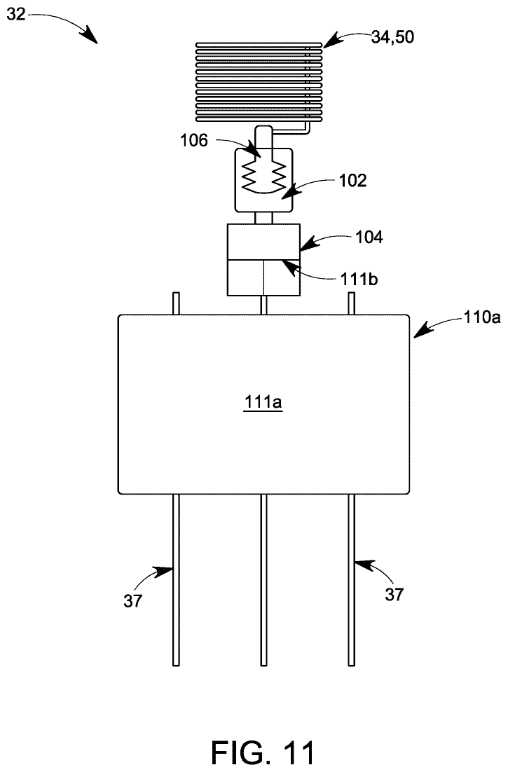

FIG. 11 shows a close-up view of a radially outer portion of a spoke of the wheel of FIG. 10;

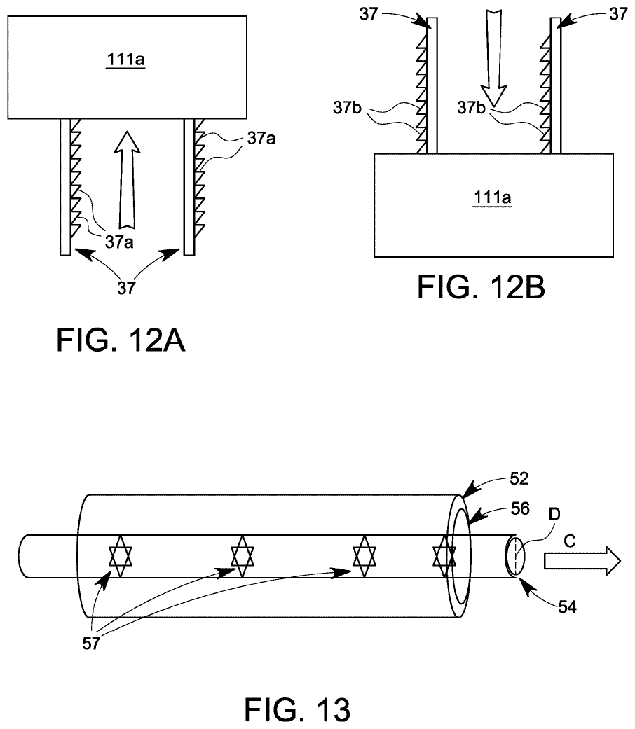

FIGS. 12A and 12B show close-up views of a locking mechanism for a spoke of the wheels as shown in earlier figures; and

FIG. 13 shows another embodiment of a working fluid expansion chamber like that shown in FIGS. 5 and 6, with internal supports.

FIG. 1 shows a portion of a heat engine 100 comprising a first chamber 102 containing a working fluid 10, and a second chamber 104 containing a hydraulic fluid 20. The first and second chambers 102, 104 are separated by a separator 106. The separator 106 is designed to keep the working fluid 10 isolated from the hydraulic fluid 20, and contained within the first chamber 102. The separator 106 is designed to move or change shape (e.g. bend, expand, or contract) in response to volume changes of the working fluid. The separator 106 is selected to be non-reactive with both the working fluid 10 and the hydraulic fluid 20.

In the example pictured in FIG. 1, the separator 106 is a flexible diaphragm separator 106—it will appreciated that a wide variety of different separator designs may be used in other embodiments. FIG. 1 indicates the two extreme positions of the flexible separator 106 around a central line (one curving leftwards as pictured, into the first chamber 102, when the working fluid 10 is at its smallest volume, and the other curving rightwards as pictured, into the second chamber 104, when the working fluid 10 is at its largest volume). Any separator 106 may be used provided it fulfils the functions of (i) separating the working fluid 10 from the hydraulic fluid 20, whilst still (ii) enabling the transfer of force from the working fluid 10 to the hydraulic fluid 20.

The working fluid 10 is selected to expand when heated, e.g. by application of a heat source, H. When at a first temperature, which may be ambient temperature, the separator 106 is in a first position, curving into the first chamber 102 (leftwards in the diagram). As the working fluid 102 is heated above ambient temperature/the first temperature, it expands, causing the separator 106 to move towards and though the central position and into the volume previously filled with the hydraulic fluid 20. The hydraulic fluid 20 is therefore arranged to be moved by the expansion of the working fluid 10, being pushed by the separator 106 as the separator 106 moves in response to a volume change of the working fluid 10. The first chamber 102 may be referred to as an expansion chamber 102, as it is the chamber in which work (in the form of applied heat) is done on the working fluid to cause it to expand.

The second chamber 104 comprises a portion 104a arranged to receive a piston 110a, this portion of the chamber 104 being in the form of a narrower passageway extending away from the separator 106 in the example pictured. The piston-receiving portion 104a contains a piston 110a which is arranged to be pushed outwardly by the moving hydraulic fluid 20. The piston 110a forms a part of a drivetrain 110 of the heat engine 100. The drivetrain 110 is therefore arranged to be moved by the hydraulic fluid 20, which in turn is moved by the working fluid 10. The drivetrain 110 is therefore shielded from the working fluid 10, which never comes into contact with the piston 110a. The second chamber 104 as a whole may be referred to as a piston chamber, and, in some embodiments, may have a constant width selected to slidingly receive the piston 110a instead of having a narrower portion for the piston 110a. The second chamber 104 may also be referred to as a hydraulic chamber, as it contains the hydraulic fluid 20.

The piston 110a relays the motive force and mechanical energy to other components of the drivetrain 110. In some embodiments, the drivetrain 110 may be arranged to power an electrical generator. In alternative or additional embodiments, the drivetrain 110 may be used to do useful mechanical work directly, e.g. acting as a pump.

In various embodiments of the invention, apparatus 100 as shown in FIG. 1 may be located on each spoke of a wheel as described below, each spoke having its own piston 110a, and the wheel as a whole being connected to the rest of the drivetrain 110. The drivetrain 110 may therefore comprise multiple pistons 110a, and multiple physically-separated hydraulic fluids and working fluids. Each spoke of the wheel may therefore comprise its own, independent, heat engine.

When the heat source, H, is removed—e.g. by turning off or moving the heat source, or by moving or shielding the heat engine 100—the working fluid 10 contracts and the separator 106 returns to its initial position. The hydraulic fluid 20 can then flow back into the volume vacated by the separator 106, as the piston 110a moves back to its initial position (leftwards in the example pictured) as the pressure on it from the hydraulic fluid 20 reduces. This cycle may be repeated, and reciprocating motion may therefore be provided. In some embodiments, active cooling may be provided to hasten the return to the initial position when the heat source, H, is no longer being used to heat the working fluid 10. In some embodiments, pneumatic accumulators may be used to assist with returning the piston to its initial position when the working fluid contracts.

In alternative embodiments, the heat source, H, may not be removed—instead, active cooling may be used to counterbalance the heating and then the active cooling may be disabled when the working fluid 10 is to be heated again.

The selected working fluid 10 in the implementation being described has a boiling point of less than or equal to 60° C. at standard pressure (1 atm, i.e. 101.325 kPa). The working fluid 10 has a boiling point of less than or equal to 45° C. or 40° C. at standard pressure in the embodiments being described. The boiling point of the working fluid 10 may be around 40° C., e.g. 40° C.±2° C. It will be appreciated that, in use, the pressure within the expansion chamber 102 is generally significantly higher than standard pressure, and that the boiling point may be correspondingly higher.

The selected working fluid 10 has a relative density greater than 1. It will be appreciated that relative density, also referred to as specific gravity, is a measure of the density of a substance in comparison to the density of water. More specifically, relative density is the ratio of the density (mass of a unit volume) of a substance to the density of a given reference material (here, water) measured at room temperature (20° C.) and standard atmospheric pressure (101.325 kPa), and is therefore unitless. The working fluid 10 has a relative density of greater than or equal to 1.1, 1.2, or 1.3 in some implementations. The relative density of the working fluid 10 may be around 1.3, e.g. 1.3±0.1 .

The working fluid 10 of various implementations may have a specific heat capacity, i.e. heat capacity per unit mass, of less than or equal to 3.5, 3, 2.5, 2, or 1.5 J/(kg ° C.). The specific heat capacity of the working fluid 10 may be less than or equal to 1.2 J/(kg ° C.). The specific heat capacity of the working fluid 10 may be around 1.2 J/(kg ° C.), e.g. 1.2±0.1 J/(kg ° C.). The specific heat capacity is defined as the quantity of heat (J) absorbed per unit mass (kg) of the material when its temperature increases by 1 Kelvin (or equivalently by 1° C.), and its units are J/(kg K) or J/(kg ° C.). The specific heat capacity may be measured at room temperature (20° C.).

The working fluid 10 may be or comprise dichloromethane (DCM), and for example may be at least 90-95% dichloromethane by volume. The working fluid may comprise DCM mixed with small amounts of one or more other organic solvents, such as benzene.

Following various experimental tests, DCM was chosen as the working fluid 10 for many embodiments due to its high specific gravity (1.3) and low boiling point of ~40° C.. The large pressure increase as the working fluid 10 reaches its boiling point may allow relatively low temperature heat to be converted into useful mechanical energy. DCM usage has previously been limited due to the cost of maintenance and corrosive properties of the fluid which requires costly, specialised equipment—as a result, it has not been used successfully in a commercial Carnot cycle-based heat engine previously. The use of a hydraulic fluid 20 to separate the drivetrain from the working fluid 10, and of a Carnot-based cycle rather than a Rankine cycle so as to avoid mechanical pumping of the working fluid 10, enables fluids previously deemed to be unsuitable to be used as working fluids 10 in heat engines 100. It will be appreciated that DCM is listed by way of example and is not intended to limit the invention any alternative fluid having similar properties of low boiling temperature and high specific gravity may be used in its place, or in combination with DCM if appropriate. The working fluid 10 should also have a relatively low specific heat capacity to facilitate the conversion of heat transfer to mechanical work.

The hydraulic fluid 20 may be a relatively viscous liquid (as compared to the working fluid 10), and may be oil based. The hydraulic fluid 20 may be or comprise glycol ether polymers, or any suitable oil(s), synthetic or otherwise. Any suitable generic hydraulic fluid 20 may be used, for example a polyol ester or another suitable synthetic hydrocarbon.

FIG. 2 illustrates a second (unclaimed) heat engine 200, this time with the drivetrain 110 connected to an electrical generator 120. It will be appreciated that various features described with respect to this heat engine 200 can also be applied to the gravity-heat engine 300 described and claimed herein. In particular, the principles described can be used for each spoke 32 of the wheel 300 and are shown and described for a single volume of working fluid 10 here for simplicity.

The generator 120, powered by the heat engine 200, powers a light-emitting diode (LED) light-board 130 in the example pictured. Experimentation has shown that a heat source, H, of just three tea-light candles can be used to easily generate sufficient electricity to power a light-board 130 with ten 10 W LEDs with such a heat engine 200.

In this heat engine 200, a coolant, or source of cooling, C, is provided as well as a heat source, H, so allowing the cooling of the working fluid 10 to be faster. In some implementations, the coolant C may lower the working fluid 10 to below the ambient temperature around the heat engine 200.

The heat engine 200 of FIG. 2 comprises two heat exchangers 50a, 50b, which may be referred to as heat exchange paddles. These heat exchange paddles 50a, 50b comprise pipes containing the working fluid 10, the pipes acting as expansion chambers 102. A set of parallel pipes may extend across the paddle 50a, 50b, recombining to form a single pipe on leaving the paddle 50a, 50b. In some implementations, multiple layers of pipes may be provided in the head of each paddle 34 to provide a larger flow volume of the working fluid 10, or a larger surface area for the same volume. Multiple sets of parallel pipes may therefore be provided in a layered arrangement, optionally with some offsetting of pipe sets to allow for a greater exposed surface area.

The paddles 50a, 50b are substantially flat, providing a large surface area to volume ratio for ease of heat exchange. The paddles 50a, 50b are substantially rectangular in shape in the example shown, although it will be appreciated that shapes may vary in other implementations. These paddle designs may be used for the heat exchanger of each spoke 32 of a gravity-heat engine 300 as described herein. The paddles 50a, 50b of the heat engine 200 shown in FIG. 2 are arranged to be moveable as indicated by the thin arrows; in particular being rotatable between horizontal and vertical positions. This movement is replaced by wheel rotation for a gravity-heat engine 300 as described herein.

FIG. 2 schematically illustrates use of a source of heating, H, and a source of cooling, C. In the horizontal position, a paddle 50a is held above the heat source, H, so causing the working fluid 10 to expand. The first paddle 50a is then moved to a vertical position and cooled by a source of cooling (not shown) to cause the working fluid 10 to contract, so completing the cycle. A motor and/or actuator may be used to move the paddle 50a. Whilst the first paddle 50a is in the horizontal position and being heated, the second paddle 50b is in a vertical position and being cooled by a source of cooling, C. When the first paddle 50a is moved to the vertical position, the second paddle 50b may be moved to a horizontal position, optionally taking the original place of the first paddle 50a. The same source of heat, H, may be used to heat each paddle 50a, 50b in turn. A separate source of cooling may be used for each paddle 50a, 50b, or the same source, C, may be used, depending on the arrangement.

In the example pictured, a single, central, heat source, H, is used for both paddles, and is arranged to provide heat continually. By contrast, a separate source of cooling, C, is used for each paddle 50a, 50b, one cooling source on either side of the heat source. The sources of cooling may be switched on and off as desired, e.g. by opening and closing a valve from a water reservoir. In alternative implementations, the paddles 50a, 50b may swap places when they move, and the same source of cooling may be used for each. The source of cooling may also be continual in such implementations.

The heat source, H, may be constant, providing continual warmth to the outside of a heat exchange paddle 50. A heat exchange layer 52 of the paddle—optionally in the form of a thick wall around each pipe of a set of parallel pipes—may accumulate heat in use. This heat exchange layer 52, or heat accumulator layer 52, may be made of steel. The heat exchange layer 52, which may also be described as a heat storage layer 52, may be relatively thick-walled so as to facilitate maintenance of a fairly constant temperature (e.g. ±5° C. or ±2° C.) of the heat storage layer 52 in use (assuming an at least approximately constant heat source is provided). Retaining the heat exchanger 50 above ambient temperature may improve system efficiency.

In the heat engine 200 being described, within the thick-walled heat exchange layer 52 is a coolant flow channel 54. This channel 54 is concentric with the cylindrical thick-walled heat exchange layer 52, so providing a central pathway for coolant flow, C. The flow channel 54 may be provided by a relatively thin-walled, non-corrosive, steel tube. The use of metal to make the thin tube wall may allow for good heat transfer without reducing strength deleteriously. The coolant flow, C, may be turned on and off in use, so allowing cooling to be started and stopped. The coolant flow channel 54 may be drained when the coolant flow is stopped/when the paddle 50a, 50b moves away from the coolant flow. In the apparatus 200 shown, moving the paddle 50a, 50b to the vertical position may align a cooling flow inlet of the paddle 50a, 50b with the coolant flow, C, and the coolant may simply flow through the paddle 50a, 50b and out via a lower coolant exit under gravity. When a sufficient reservoir (e.g. of water) above the paddle 50a, 50b is available, no pumping of water may therefore be required.

It will be appreciated that these features can also be applied to the gravity-heat engines 300 of various aspects of the invention, and are described here with respect to a simpler heat engine design 200 for clarity. A coolant flow, C, may be provided from a reservoir above a wheel, for example, and heat exchanger “paddles” 50 can be provided around the wheel's rim.

As shown in more detail in FIG. 6, in the heat exchangers 50 of various embodiments a passageway 56 is provided around the coolant flow channel 54, extending between the coolant flow channel 54 and the heat exchange layer 52. The passageway 56 is arranged to contain the working fluid (e.g. DCM) in use. The passageway 56 is arranged to be thin compared to both the heat exchange layer 52 and the coolant flow channel 5—e.g. having a width of no more than 50%, and preferably no more than 30%, 25% or 10% the width (here, diameter, for a circular pipe) of the coolant flow channel 54. It will be appreciated that the cross-section of one or more of the layers 52, 54, 56 may not be circular in other embodiments.

In alternative embodiments, coolant (e.g. water) may simply be caused to flow over and across the heat exchange paddles 50a, 50b, instead of through internal passageways 54. No thick-walled heat accumulation layer 52 may be provided in some such embodiments. A reduction in thermodynamic efficiency may be accepted in favour of increased simplicity of parts in such embodiments.

Whilst the heat source, H, is constant in the embodiments being described, the cooling effect can be varied. In the embodiments being described, the source of cooling, C, is a flow of coolant (more specifically, water) through and/or over the heat exchanger(s) 50. Water leaving the heat exchanger 50 may then be returned to a tank (not shown) or other storage vessel (optionally a reservoir at a lower level than the one it came from), optionally via coiled pipes exposed to the air to hasten cooling back to ambient temperature.

Flow of the coolant, C, may be controlled by a pump in some embodiments. In such embodiments, the pump may be powered by the drivetrain 110, either mechanically or electrically via a generator 120, in some implementations. The pump can be turned on and off at intervals—the working fluid 10 is cooled by the coolant, C, when coolant is pumped through (or over) the heat exchanger 50, so contracting. When coolant is not being pumped through the heat exchanger 50, the heating effect from the heat source, H, dominates and the working fluid 10 is heated, and so expands. Work is done by the repeated heating and cooling of the working fluid 10. One or more controllable valves may be used in addition to a pump. In other embodiments, a pump may be used to return water (or other coolant) from a lower reservoir to a higher reservoir, but the flow of coolant through or across the heat exchanger 50a, 50b may be driven by gravity (as in the example of FIG. 2) rather than pumping—one or more valves may be provided to start and stop the flow as desired.

In the engine 200 of FIG. 2, the movement of the paddles 50a, 50b from the “hot zone” to a second position for cooling therefore creates a reciprocating motion of the drivetrain 110 despite the constant heat input, H. It will be appreciated that rotation of the wheel 300 of various embodiments of the invention similarly moves paddles between a “hot zone” and a second region for cooling.

Water (or another coolant, in other embodiments) is passed through the inner tubes 54 of the heat exchanger 50 to cool the working fluid 10 (e.g. DCM) which is enclosed in the outer chamber 56, between the cooling channel 54 and the heat exchange layer 52 in the embodiment being described, although it may simply be caused to flow across the outer surface of the paddle 50a, 50b in other embodiments. Flow rates may be adjusted as appropriate depending on the size and design of the apparatus and the desired temperature change.

As the working fluid 10 expands and contracts within the passageway 56, the heat exchanger 50 may be described as comprising one or more expansion chambers 102. A single heat engine 100, 200, 300 may therefore comprise a plurality of expansion chambers 102, optionally all heated and cooled by the same sources C, H. The thick-walled outer layer 52 stores heat and keeps a relatively constant temperature whilst also providing a strong outer wall or support for the passageway 56 containing the working fluid 10. The relatively thin-walled inner tube 54 allows intercooling using a coolant such as water. The inner tube 54 may be supported by one or more insert supports 57 which counter the inwards pressure on the tubes 54 when the working fluid 10 expands. The insert supports 57 (not shown in FIGS. 5 and 6, but shown in FIG. 13) may be made of a thermally-insulating and electrically-insulating material.

In the embodiment shown in FIGS. 5 and 6, the expansion chamber 102 comprises a single, central, inner passageway 54 for the coolant. In other embodiments, the inner passageway 54 may not be central, and/or there may be multiple inner passageways 54 within a single working fluid passageway 56—for example, three inner coolant passageways 54 may be located within a single working fluid passageway. Increasing the number of inner passageways 54 may increase the heat transfer surface area, but may also increase complexity, mass and/or cost of the apparatus 300—a trade-off may therefore be considered, noting that the increased pipe mass and higher flow resistance in narrower passageways 54 may reduce efficiency where multiple inner coolant passageways are used in a given expansion chamber. These specialised expansion chambers 102 of the heat exchanger 50 may therefore allow rapid cooling and heating of the working fluid 10, and are built to sustain the relatively high pressures exerted by the expansion of the working fluid 10 when heated.

The expansion chamber(s) 102, 56 within the heat exchanger 50 therefore contain the working fluid 10 (e.g. DCM) and have an enclosed thin inner tube 54 (which may be welded) which is arranged to have the coolant (e.g. water) flow therethrough to rapidly cool down the heated expansion chamber(s) 102, so cooling the working fluid 10. In a heat exchanger 50 as shown, pipework containing the working fluid 10 may split into multiple parallel pipes within the heat exchanger 50, so providing a greater pipe surface area for heat transfer than if all of the working fluid 10 flowed through a single, larger, pipe. Each parallel pipe section may be described as being an expansion chamber 102, or as being a part of a larger expansion chamber comprising the interlinked pipe sections. The expansion chambers 102 in this arrangement are all interlinked to provide a higher volume and therefore more capacity for work done by the working fluid 10.

In the embodiments being described with coolant passageways 54, the coolant passageways 54 are used only for a flow of relatively cold water from a reservoir under gravity, to cool the working fluid 10. In the heating phase of the cycle, the coolant passageways 54 are not actively used, and are generally empty (not including trace remaining water, and atmospheric air). The coolant passageways 54 may not have a permanent connection to a coolant source (e.g. a reservoir), instead having an opening which is oriented such that a flow of coolant can enter the coolant passageways 54 when the apparatus 300 is correctly aligned, and the relevant spoke 32 is in the correct position. In the heating phase of the cycle, heat is generally provided from heated air at that side of the apparatus 300. Whilst some of this air may enter the passageways 54, it is generally not specifically controlled to do so, and the majority of the heat transfer to the working fluid 10 may come from the thick-walled outer layer 52, rather than from the inner passageways 54. As such, the dominant direction of heat transfer within the heat exchanger 50 may generally be inward throughout the cycle, with heat being transferred from the outer layer 52 to the working fluid 10, and from the working fluid 10 to the coolant in the inner passageways 54. The heat transferred to the coolant is then lost when the coolant flows out of the passageways 54/out of the apparatus 300.

FIG. 3 shows a heat engine 300, in which gravitational energy is used in addition to heat to generate useful work; the engine 300 may therefore be referred to as a gravity-heat engine 300. The engine 300 takes the form of a wheel 30 or cylinder, arranged to rotate around a central axle. For brevity, the form is referred to as a wheel herein, but it will be appreciated that the engine 300 may have a significant length along its rotation axis, with FIG. 3 simply showing a wheel-like cross-section. It will be appreciated that the “wheel” is also not required to be circular—it may be polygonal. The wheel 30 is arranged to be oriented vertically in use, i.e. to have its rotation axis in a horizontal plane and a wheel diameter in a vertical plane. The wheel 30 has a plurality of radial spokes 32 extending between a hub 31 of the wheel 30 and the outer circumference, or rim, of the wheel 30. In the embodiment shown in FIGS. 3 and 4, the wheel 30 has a total of twelve radial spokes 32. It will be appreciated that the number of radial spokes 32 may vary in other embodiments—for example a wheel 30 may have a total of eight radial spokes 32, as shown in FIG. 10. In general, a minimum of three, four, or five spokes may be present for a wheel 30 as described herein. More, and/or thicker, spokes 32 may be provided on a larger wheel 30.

In embodiments in which the engine 300 takes the form of an elongate cylinder rather than a disk, multiple sets of radial spokes 32 may be provided at regular intervals along the axis. Alternatively or additionally, each radial spoke may also have a significant axial extent in cylindrical arrangements.

Each spoke 32 comprises a piston 110a slidingly received within a piston chamber 104. It will be appreciated that, in some embodiments, additional support spokes which do not comprise pistons may be provided—e.g. for structural reasons. In other embodiments, the spokes 32 described in detail herein may be the only spokes of the wheel 30. As used herein, terms such as “each spoke” refer to each spoke with a piston; any support spokes are ignored for clarity of description.

Each spoke 32 is arranged such that its respective piston 110a can slide radially along at least a portion of its length (generally, along at least 30% of its length and preferably at least 60% of its length). The hub 31 may define a minimum distance from the rotation axis of the wheel 30 which a piston 110a can reach, and the rim of the wheel (and, in many cases, heat exchangers 50 arranged around the rim) may define a maximum distance from the rotation axis of the wheel 30 which a piston 110a can reach. Each radial spoke 32 has its own piston 110a—there may therefore be as many pistons 110a as there are radial spokes 32 (ignoring any support spokes).

Each piston 110a is weighted—in particular having a heavy “head” relative to other spoke components in some embodiments. In other embodiments, such as that shown in FIGS. 10 and 11, a dedicated weight 111a of the weighted piston 110a may be offset from the head 111b of the piston along the shaft of the piston—for example with a smaller head 111b within a piston chamber 104 and a piston weight 111a outside of, and radially inward of, the piston chamber 104. The piston weight 111a may therefore have larger dimensions than the piston chamber 104. A weight block 111a of any suitable dimensions may therefore be located wherever is appropriate on a piston 110a in various embodiments. Movement of the piston 110a therefore significantly affects weight distribution of the spoke 32, as the weight moves along the radius/along the spoke's length.

Moment of force (often simply referred to as moment) is a measure of a force's tendency to cause a body to rotate about a specific point or axis under gravity, and is defined as the force multiplied by the perpendicular distance from the rotation axis. Moving the weighted piston 110a radially outward—away from the wheel's hub 31—therefore increases the moment under gravity of that spoke 32, assisting rotation of the wheel 30. The direction of rotation under gravity caused by a moment depends on the location of the weight with respect to the vertically-oriented wheel—in particular, on which side of the rotation axis the weight lies. A net downward moment to the right of the axis will drive clockwise rotation whereas a net downward moment to the left of the axis will drive anti-clockwise rotation. Movement of the pistons 110a, and in particular of the weight 111a, can therefore be used to drive rotation of the wheel 30. Pistons 110a at different regions within the wheel must be in different radial positions so as to provide a resultant moment for the wheel 30 to drive rotation, rather than balanced moments.

With a vertically-oriented wheel 30 as shown in FIG. 3, a vertical line can be pictured bisecting the wheel 30, and dividing the wheel 30 into two portions (in this case, two half-disks, or half-cylinders if the wheel has a significant axial extent, with semi-circular cross-sections). As the wheel 30 rotates, which spokes 32 are in which portion changes, with each spoke entering, moving through, and then leaving each portion in turn.

A fluid is located within the piston chamber 104 and arranged to cause the piston 110a to move along the radial spoke 32 in response to heating or cooling. In the embodiment being described, the fluid within the piston chamber 104 is a hydraulic fluid 20, and is arranged to be moved by a working fluid 10 so as to move the piston 110a. In other embodiments, the fluid within the piston chamber 104 may itself be a working fluid 10, and no separate hydraulic fluid may be used. In the embodiment being described, the hydraulic fluid 20 is located between the piston 110a and the rim 39 of the wheel 30, such that heating causes the piston 110a to move inwardly along the spoke 32 (towards the wheel's hub 31) and cooling causes the piston 110a to move outwardly along the spoke 32. However, it will be appreciated that this may be reversed in other embodiments, such that the fluid is located nearer to the wheel's hub 31, and heating drives the piston 110a outwardly towards the wheel's rim 39.

A heat source, H, is used to apply heat to one portion (at least approximately a vertically-split half-disk) 30a of the wheel 30. As shown in FIG. 3, the heat source, H, is applied to a lower region of the wheel 30, where each spoke 32 in turn first enters the heated region 30a. The highest-intensity heating is therefore applied at the bottom of the wheel 30, causing relatively rapid expansion of the working fluid 10. This expansion pushes the hydraulic fluid 20, so pushing the piston 110a upwards, towards the wheel's hub 31. Once the spoke 32 has rotated through 90° of the heated half-disk 30a, gravity then assists retaining the weighted piston head 110a nearer to the hub of the wheel. Even if the working fluid 10 is a little cooler towards the top of the wheel 30 than it was shortly after entering the heated region 30a at the bottom of the wheel, gravity may therefore retain the piston 110a in the desired position until the spoke 32 leaves the heated region 30a. (In some embodiments, a locking mechanism 37a, 37b as described below may also be provided to ensure the piston 110a is held in position before then being released when it reaches a desired position.)

The other half-disk 30b is not heated, and, in the embodiment being described, is actively cooled. In the embodiment being described, a coolant reservoir containing a coolant, C, (e.g. water) is located above the wheel 30 such that a flow of coolant can be provided under gravity simply by opening one or more valves. In some embodiments, a shower-type arrangement may be used, simply proving a constant stream of the coolant over the cooled portion 30b of the wheel 30. In other embodiments, the coolant C is arranged to flow in one or more passageways 54 within each spoke 32, in particular flowing within a heat exchanger 34, 50 of each spoke 32 so as to provide more effective cooling. The coolant passageways 54 may be arranged to drain under gravity as the spokes 32 reach the bottom of the wheel 30. Rapid cooling may therefore be provided by exposure to a coolant flow, C.

In particular, in the embodiment being described each spoke 32 comprises a heat exchanger 50, which may be referred to as a heat exchange paddle 34 of the wheel 30 as described in more detail below. The working fluid 10 and the coolant, C, may both be arranged to flow through (separate) passageways in this heat exchanger 50, optionally separated by only a thin and thermally-conductive wall so as to improve heat transfer. As described above with respect to FIG. 6, in various embodiments the heat exchange passageways 54, 56 for the coolant and working fluid may be concentric, and may be surrounded by a heat accumulator layer 52 arranged to store some heat. In general, it has been found that expansion on heating the working fluid 10 takes around four times as long as the contraction on cooling the working fluid with heating and cooling processes as described herein, and the heat accumulator layer 52 has been found to assist in maintaining a higher average working temperature without deleteriously affecting cooling rates provided that the coolant can reach the working fluid 10 for heat transfer. The use of a passageway 54 for coolant, C, within the working fluid 10 facilitates this arrangement.

FIG. 13 shows further detail of such heat exchange passageways 54, 56, with an arrow indicating flow of coolant, C—in particular, the coolant passageway 54 comprises internal supports 57 within the passageway 54, the internal supports 57 being used to reinforce the passageway walls against the pressure of the working fluid 10 without unduly blocking coolant flow. It is desirable to avoid heat transfer to this support structure 57 insofar as possible, so a thermally-insulating material may be selected. A suitable ceramic material may be used, for example. A minimal contact area with the circumference of the coolant passageway 54 may therefore also be desirable to reduce heat transfer—a star spoke design as shown in FIG. 13 allows for six struts to cross the passageway with only six wall-contact points. It will be appreciated that this arrangement is shown by way of example only, and is not limiting. Shape and design of the support 57 may also take into account available materials, the diameter, D, of the coolant pipe 54, and the desire to avoid trapping of water within the pipe 54 and support structure 57 (for example, the star spoke design shown leaves the centre of the passageway 54, where fluid flow is likely to be fastest, unobstructed, so potentially reducing the amount of turbulence caused).

To allow for rapid cooling of the working fluid 10 in the cooling phase, the wall thickness of the inner channels 54 may be minimised, and the selected material for the wall may be one with a high thermal conductivity. Using a metal may allow sufficient strength to be provided by a thin wall, whilst also providing high thermal conductivity. The resultant improved transfer of heat between the coolant, C, and the working fluid 10 may improve efficiency. A wall thickness as low as 0.2 mm-0.3 mm may be possible for the coolant passageways 54, for example, with selection of suitable wall materials and inner reinforcements 57. The coolant pipes 54 may therefore be structurally reinforced so as to avoid implosion from the high pressures of the working fluid 10, whilst minimising thermal losses. Support inserts 57 made of a suitable ceramic material, or other poor thermal conducting material, may be used to give the passageway 54 the structural rigidity to withstand the high pressures.

In additional or alternative embodiments, a sprayer or mister may be provided to spray the cooled portion of the wheel 30b with a coolant. In such embodiments, no coolant passageways 54 may be provided within the path of the working fluid 10, and the dominant heat transfer direction may reverse between heating and cooling sections of the cycle, with heat flowing inwards when the heat exchanger 50 within which the working fluid flows is exposed to the heat source, and outwards when the surface of the heat exchanger 50 is cooled. The source of coolant may be applied around the whole of the unheated half-disk 30b rather than just from the top in such embodiments.

Once the spoke 32 has rotated through 90° of the unheated half-disk 30b, gravity then assists retaining the weighted piston head 110a nearer to the rim 39 of the wheel. Gravity may therefore retain the piston 110a in the desired position until the spoke 32 leaves the unheated region 30b, even if a small amount of “leaked” heat from the heat source, H, starts to warm the working fluid 10 before it has properly entered the heated region 30a. In some embodiments, a locking mechanism may also be provided to ensure the piston 110a is held in position before then being released when it reaches a desired position.

In the embodiments currently being described, the hydraulic fluid 20 is located radially outward of the piston 110a, between the piston 110a and the rim of the wheel 30, such that the piston 110a moves inwardly, towards the hub 31, when the working fluid 10 expands and pushes the hydraulic fluid.

In the embodiments currently being described, the working fluid 10 is also located radially outward of the piston 110a, although offset from the piston 110a along the axis of the wheel 7 as shown in FIG. 7, which is described in more detail below. However, it will be appreciated that the working fluid 10 could be differently-located with the direction of movement of the piston when the working fluid expands being controlled by the nature of the connection between the expansion chamber and the piston chamber. The use of a separate hydraulic fluid 20 and working fluid 10 may therefore provide more flexibility in working fluid location. It will be appreciated that, in the embodiment 300 pictured, the sources of heating, H, and cooling, C, are generally applied at least initially to a rim 39 of the wheel 30, and that having the working fluid 10 located at or near the wheel rim may therefore be beneficial for rapid expansion and contraction.

In some embodiments, the fluid located within the piston chamber 104 is a working fluid 10—the piston chamber 104 may also be the expansion chamber 102 in such embodiments and no separator may be needed. In such embodiments, the working fluid 10 may be located between the hub and the piston, and the apparatus may be arranged to cause the piston 110a to move outwardly along the radial spoke 32 when the working fluid 10 expands in response to being heated and inwardly along the radial spoke 32 when the working fluid 10 contracts in response to being cooled. Alternatively, in other such embodiments, the working fluid 10 may be located between the wheel rim 39 and the piston, and the apparatus may be arranged to cause the piston 110a to move inwardly along the radial spoke 32 when the working fluid 10 expands in response to being heated and outwardly along the radial spoke 32 when the working fluid 10 contracts in response to being cooled.

However, in the embodiment being described, an arrangement more similar to that described with respect to FIGS. 1 and 2 is used—the fluid located within the piston chamber 104 is a hydraulic fluid 20, and is arranged to be moved by the expansion and contraction of a separate working fluid 10 so as to cause the piston 110a to move. A separator 106 is therefore provided between the two fluids, as is described in more detail with respect to FIG. 7, below. In this embodiment, the hydraulic fluid 20 is located between the piston 110a and the wheel rim 39, so causing the piston 110a to move inwardly along the radial spoke 32 when the working fluid 10 expands in response to being heated. The piston 110a then returns outwardly along the radial spoke 32 when the working fluid 10 contracts in response to being cooled, for example driven by air compressed by the piston movement explaining, or air re-entering a chamber or other region it was forced out of by the piston movement. A pneumatic accumulator 38 may play a role in this return to the piston's original position in some embodiments. As such, in the embodiments being described, the pistons 110a are moved inwardly as they enter the heated portion 30a of the wheel 30 (at the bottom of the wheel 30), decreasing their moment and so reducing the resistance to clockwise rotation, and are then moved outwardly when they enter the unheated/cooled portion 30b of the wheel, increasing their moment and so driving rotation of the wheel 30 (in a clockwise direction in the example pictured). Continuous rotation in the same direction may therefore be provided without any movement of the heat source, H. Whilst FIG. 3 shows the heated 30a and unheated 309b portions touching, it will be appreciated that a thermally insulating barrier may generally be provided between the two regions to reduce heat transfer into the region of the cooler portion 30b of the wheel.

Each piston 110a inherently has some mass, but in the embodiments being described each piston 110a is specifically designed to have a weight 111a—which may be an integral part of the piston 110a or may be a dedicated component connected to a head or rod of the piston—the weight 111a being arranged to provide a moment under gravity so as to drive rotation of the wheel 30. A centre of mass of the piston 110a as a whole may be arranged to lie within the weight 111a. The weight, or weighted head, 110a 111a of the piston 110a may have a density much greater than that of the working fluid 10 (or of the hydraulic fluid 20 where present), for example being made of metal. The weight, or weighted head, 110a, 111a of the piston therefore provides a localised mass. The weight 110a, 111a may be shaped to be relatively narrow in the radial direction, to provide a moment at a well-defined point along the radial spoke 32, for example being substantially disc-shaped, with a height (its smallest dimension) parallel to the radius of the wheel. The weight 110a, 111a may have a relative density of greater than or equal to 3, and optionally of at least 7, and may be made of a metal such as steel. The weight 110a, 111a is arranged to move when the piston head 110a moves, and is, or is a part of, the piston head 110a in some implementations.

The use of solid weighed pistons with a well-localised centre of mass in the radial direction may therefore facilitate obtaining a maximum power output from the wheel, for example because a radially narrow weight can provide a centre of mass very close to the rim, moving the moment of the weight radially outward along the spoke 32 to a position very close to the rim to provide the greatest turning force. The working moment between the two opposing spokes 32 (i.e. of two spoked diametrically aligned across the wheel) is key to generating high powers and the use of independent, solid, weighted pistons has been found to facilitate this. Power output can be scaled depending on wheel size (spoke length) and weight of the pistons.

In various embodiments, the movement of the piston 110a in response to heating and expansion of the working fluid 10 may compress some air in a part of the piston chamber behind the weighted head 110a of the piston, and expansion of that air when the working fluid 10 contracts may assist in returning the piston 110a to its previous position. In other embodiments, air pressure of the surrounding, ambient, air may be sufficient to return the piston 110a to its previous position once the working fluid 10 contracts, so removing the pressure of the fluid on the piston 110a. However, in the embodiment being described, a pneumatic accumulator 38 is provided for each spoke 32, at or near the hub of the wheel 30. Each spoke 32 comprises an air-tight tube, or other container, extending all the way to the accumulator 38 or hub 30 in such embodiments, allowing a fluid therewithin (which may be air) to be pressurised instead of escaping to the environment. This container may be referred to as a pneumatic chamber. Whilst the fluid in the pneumatic chambers may generally be air, other fluids may be used in some embodiments. In embodiments in which the piston 110a is located further from the wheel rim/closer to the hub, the accumulator 38 may instead be located at or near the rim of the wheel. Each accumulator 38 is arranged to store pressure. This pneumatic pressure is arranged to be opposite to the pressure applied by the working fluid 10 when it expands, so working like a trigger to push the weight of the piston 110a rapidly outwards once the pressure from the working fluid is removed by the cooling effect. Within the heated region 30a, the expansion of the working fluid 10 does work against the pneumatic pressure as well as against the weight of the piston 110a—this work is done as the spoke 32 enters the heated region 30a, continuing as the spoke 32 moves through the heated region 30a, with less relative work being done on the weight by the working fluid 10 as it rises above the mid-point, as gravity then assists in holding it nearer to the wheel's hub.

In the embodiments being described, there is no active control of the accumulators 38—instead, they passively and automatically exert a restoring force on the piston 110a to return it to its initial position once the working fluid 10 is no longer exerting a (significant) pressure on the piston 110a. In alternative embodiments, some active control may be in-built, for example to assist the piston 110a in reaching an extreme position.

FIG. 4 illustrates the engine 300 of FIG. 3 in three different rotational positions, with an outer end of the same selected radial spoke 32 circled in each of the three images to indicate the movement. The arrows indicate the (clockwise) direction of movement. As the highlighted spoke 32 enters the heated region 30a on the left-hand side of the wheel 30 as pictured, the working fluid 10 within the spoke expands, moving the weighted piston 110a inwards, towards the wheel's hub. When that spoke 32 reaches the cooled region 30b, when it reaches the top of the wheel 30 and passes into the right-hand side of the wheel as pictured, the working fluid 10 contracts, removing the inward pressure on the piston 110a. The pressure in the accumulator 38 (or simply atmospheric pressure in other embodiments) then returns the weighted piston 110a outwards, towards the wheel's rim 39. This shift in weight distribution drives the clockwise rotation of the wheel 30 under gravity.

The heat source, H, retains the weights in the inner position as the spoke 32 moves through the heated half-disk. Maintenance of the weight 110a in the inner position is assisted by gravity once the spoke 32 has travelled through 90° of the heated region in the arrangement shown—less heat may therefore be needed to maintain that position towards the top of the wheel 30. When the spoke 32 then enters the cooler region 30b, the working fluid 10 contracts and the weighted piston 110a returns to an outer position, increasing the contribution to the overall, net, moment from that weight. By contrast, in the warmer region 30a the contribution to the overall, net, moment from a given spoke's weighted piston 110a is reduced as the weighted piston head is closer to the rotation axis. The moments tending to cause rotation in the anticlockwise direction are therefore smaller than the moments tending to cause rotation in the clockwise direction due to the difference in weight positions, so providing a net moment in the clockwise direction.

In the gravity-heat engine 300 being described, the working fluid 10 is contained within an expansion chamber 102 comprising a separator 106 arranged to separate the working fluid 10 from the hydraulic fluid 20. The arrangement used in this embodiment is shown in FIG. 7. The expansion chamber 102 is arranged adjacent to the piston chamber 104 along the wheel's axis, and parallel to the piston chamber 104, such that the expansion chamber 102 is not clearly visible in FIG. 3 or 4. The expansion chamber 102 and piston chamber 104 are connected such that hydraulic fluid 20 can flow from one chamber to the other but the working fluid 10 is retained within the expansion chamber 102 by the separator 106.

The separator 106 has the form of a bellow diaphragm 106 in the embodiment being described. The bellow diaphragm 106 is made from a material selected to not react with the working fluid 10 (nor the hydraulic fluid 20), and may be made, for example, of non-corrosive stainless steel. The bellow diaphragm 106 is arranged to sit between the working fluid 10 and the hydraulic fluid 20, and to act as a medium to transfer pressure from the working fluid 10 to the hydraulic fluid 20. The bellow diaphragm 106 is placed near the piston chamber 104 for ease of interconnection and flow of the hydraulic fluid 20, and near to the rim 39 of the wheel to facilitate heat transfer for the heat exchange arrangement shown. In other embodiments, the location of the heating and cooling sources H, C, may differ and heat exchanger 34, 50 style and location may be varied accordingly—the location of the separator 106 may be adjusted accordingly.

FIG. 7 is a partial cross-sectional view of a spoke 32 in an axial plane, showing the two adjacent, fluidly connected, chambers 102, 104. The chambers 102, 104 not being collinear may improve safety as, if the wheel 30 were badly damaged and the piston 110a driven too far, it would not damage the separator 106 so retaining the working fluid 10 even if the hydraulic fluid were released. In addition, the separation of chambers ensures separation of the working fluid 10 from the piston 110a—since working fluids 10 such as DCM can be corrosive, having the working fluid in the piston chamber could risk interaction with the seals, potentially causing leakage or requiring more regular and expensive maintenance.

In the embodiment shown in FIGS. 3 and 4, the gravity-heat engine 300 further comprises a plurality of heat-exchange paddles 34, one for each spoke 32. Each paddle 34 has a stem extending radially along the spoke 32 and a head connected to the stem. The heads of these paddles 34 are made of a heat-conductive material, preferably with a relatively low specific heat capacity to allow rapid heating and cooling, and are arranged to facilitate and accelerate heating and cooling of the working fluid 10. In the embodiment being described, the heads comprise a set of passageways through which the working fluid 10 is arranged to pass, so forming a heat exchanger 50. The stem may serve to hold the heat exchanger head in place, and may also support a passageway to take the working fluid 10 from the heat exchanger 50 to the expansion chamber 102 or separator 106. In some embodiments, the stem may at least partially support the piston 110a, too. One or more additional or alternative supports 37 may be provided to support the piston 110a and/or the head of the paddle in other embodiments, for example as shown by the two support beams 37 illustrated for a spoke 32 in FIG. 11. It will be appreciated that more or fewer support beams may be provided in other embodiments.

The paddles 34 may be made of metal, and optionally of specific high strength non-corrosive alloys such as those used in marine applications. The paddles 34 have a broad, flat, head on or near a circumference of the wheel 30, providing a relatively large area for heat exchange as compared to the stem of the paddle 34. Each paddle head 34 extends around a portion of the circumference and across a rim width of the wheel 30. The paddles 34 do not contact each other, as temperature varies around the wheel's circumference so the paddles 34 should be at different temperatures from each other. Each paddle 34 is arranged to transfer heat from the heat source, H, to the working fluid 10. When exposed to the cooler side of the wheel 30, C, which may be actively cooled or simply at ambient temperature, the paddles 34 can again facilitate heat transfer, making heat loss from the working fluid 10 to the environment more rapid than otherwise.

In the embodiment being described, each paddle 34 has an outward-facing opening 35 for coolant, C. When this opening 35 aligns with a valve or opening of the coolant reservoir, coolant (e.g. water) flows into the opening and from there is funnelled into one or more coolant passageways within the heat exchanger 50. Alignment with the coolant supply is arranged to occur when the respective spoke is at or near the top of the wheel 30—it will be appreciated that the system is generally arranged such that coolant does not enter the heat exchanger 50 until just after the respective spoke has moved past the vertical position and into the cooled region. The weight of the coolant within the heat exchanger 50 may also assist in driving rotation of the wheel. The opening 35 then allows the coolant to automatically drain out of the heat exchanger 50 under gravity as the spoke 32 reaches the bottom of the wheel 30.

Each spoke 32 of the engine wheel 30 therefore has its own heat exchanger 50, expansion chamber 102, separator 106, and piston 110a in the embodiments being described. The heat exchanger 50 of each spoke may comprise one or more coolant flow passageways 54 and heat storage layers 52 built into the paddle 34, optionally as described above. The heat exchange arrangement 50 as shown in FIG. 6 may therefore be applied in the head of each paddle 34.

Cooling may therefore be controlled and regulated by a reservoir, C, on the top of the cooled section 30b of the wheel 30. Once a given heat exchanger 34, 50 enters the cooled section 30b, the flow of coolant (e.g. water) cools the working fluid 10 in that heat exchanger 34, 50. Optionally, a valve of the coolant reservoir, C, may be opened and closed as a coolant passageway opening 35 reaches and moves past alignment. Coolant then flows through inner passageways 54 of the heat exchanger 50, providing rapid cooling of the working fluid 10, and hence rapid contraction.

In embodiments in which the working fluid 10 is located further from the wheel rim 39, the heat-exchange paddles may be replaced with heat-conduction paddles 34, one for each spoke 32, with the stem extending radially along the spoke having a more important role beyond structural support of the head. Each paddle 34 is arranged to transfer heat from the heat source, H, to the expansion chamber 102 on the corresponding spoke 32, so hastening heat transfer to the working fluid 10. These heat-conduction paddles 34 are made of a heat-conductive material, preferably with a relatively low specific heat capacity to allow rapid heating and cooling, and arranged to facilitate and accelerate heating and cooling of the working fluid 10. The paddles 34 may be made of metal, and optionally of specific high strength non-corrosive alloys such as those used in marine applications. The paddles 34 hasten heat transfer in the radial direction, so conducting heat from around the edge of the wheel to wherever the working fluid 10 may be located. The head of each paddle may be solid, without inner passageways, in such embodiments, or may comprise an inner passageway for example containing low-pressure water vapour to further improve heat conduction. Copper may be used for its strong heat conductance. Additionally or alternatively, the heating and cooling sources may instead be applied nearer to the hub. The heat exchangers may be differently located accordingly.

In the embodiments shown in FIGS. 3, 4, and 10, the wheel 30 has a solid rim 39. The rim 39 may serve to protect the spokes 32, and may be a part of a frame or support 36 of the wheel 30 rather than rotating with the wheel 30. In other embodiments, no physical rim may be present, and instead an outer edge 39 of the wheel 30/wheel rim (which may be discontinuous around the circumference) may be effectively formed by the heat exchange paddles 34, 50. In embodiments with a fixed, solid, wheel rim 39 (such as those pictured), the rim 39 may be separated into two parts as indicated by the difference in shading in FIGS. 3 and 4, with one side 39a being heated and the other 39b cooled. The rim 39 may be made of a material which is a good heat conductor, and may make physical contact with the heat exchange paddles 34, 50 to improve heat transfer. A relatively soft material such as graphite may be used for the rim 39 to avoid damage to the paddles 34 in such embodiments. In alternative embodiments, the rim 39 may not contact the paddles 34, and optionally may simply be present as a shield or screen for the rotating wheel 30 rather than playing a part in heat exchange. Any suitable material may therefore be selected as appropriate, and the rim may be continuous or discontinuous e.g. in the form of a wire mesh.

It will be appreciated that each piston 110a can only move along a portion of its radial spoke 32. The hub 31 provides a stop at which the spoke 32 ends, and beyond which neither the piston, nor the working fluid, nor any hydraulic fluid, of that spoke 32 can pass. Fluid therefore cannot pass through the hub 31, although one or more pneumatic accumulators 38 may be provided on a surface of, or embedded within an outer region of, the hub 31, as discussed elsewhere herein. Pistons 110 on each side of the hub 31 are therefore decoupled, even if collinear—the head 110a of each piston 110 moves independently of the other head of the other piston 110. In some embodiments, for example in embodiments with an odd number of spokes 32, there may not be any collinear pistons or collinear radial spokes. Each piston 110 may be free to move along a distance of no more than 90% of the radial extent of its spoke 32. The hub 31 may not allow anything to pass diametrically therethrough (it will be appreciated that a rotation axis/shaft may pass transversely through the hub 31). Each radial spoke 32 therefore comprises its own piston 110, and its own working fluid 10, rather than collinear radial spokes sharing a piston 110. Each spoke 32 may therefore be thought of as effectively providing an individual heat engine 100, the individual systems working together in the heat-gravity engine 300.

Each spoke 32 therefore extends between the hub 31 and the rim only (not through the hub), with one weighted piston 110 on each radius. Even in embodiments in which two radial spokes 32 are collinear with each other along a diameter of the wheel, the pistons 110 on those spokes 32 are independent of each other. Keeping the pistons 110 on each spoke 32 separate/independent allows the heat engine 300 to be more modular and controlled, so potentially providing improved efficiency in terms of utilising the generated pressure, and allowing the release of the pressure to move the weight at its maximum or minimum. This generates a closed cycle for each spoke and each spoke acts independently in a Carnot cycle.

Improved control of the moving pistons 110 is therefore provided as compared to systems with conjoined pistons with a rod passing through a wheel's hub, or any other form of coupled pistons. For example, for a wheel rotating clockwise it may be beneficial for a weight 110a on a first spoke 32 near the top of the wheel not to move radially outward until fractionally later than a weight 110a on a spoke 32 aligned with the first spoke and near the bottom of the wheel moves radially inward, or vice versa, depending on specific apparatus design and known potential issues or sticking-points for that design. Separation of the pistons 110 allows for independent movement of all weights 110a, 111a.

Such a modular system, with decoupled pistons 110, may facilitate utilisation of the higher pressures generated by the expanding liquid as the volume of working fluid used and forces generated in each spoke 32 may be lower, as each spoke 32 has its own weight 110a, 111a rather than a larger weight moving across two conjoined radial spokes (i.e. a diametric spoke) This may allow effective and efficient use of the pressure generated to do mechanical work whilst and avoiding the safety and complexity concerns of higher pressure with larger working fluid volumes. The smaller, individual heat exchangers for each spoke 32 may also allow for a more direct and rapid cooling and heating, and so higher efficiencies. In various examples describe herein, pressures of at least 15 KPa were generated using 20 ml of working fluid without straining the materials or any safety concerns (e.g. explosion risk).

Each individual spoke can therefore operate independently, and may have its own pneumatic accumulator 38. The pneumatic accumulator 38 on each spoke may also act as, or form part of, a locking mechanism arranged to allow the weight 110a, 111a of its spoke 32 to be temporarily locked in position. Such a locking mechanism may therefore allow the hold and release of the pistons 110 on demand, to improve smooth rotation of the wheel. The pistons 110 may therefore move rapidly from a first position to a second position on release, driven by accumulated pressure behind them, rather than moving steadily along the spoke 32 as pressure builds. This more rapid change in piston position, and therefore in weight position and resultant moment, may assist in driving rotation of the wheel.

In various embodiments with locking mechanisms, a locking mechanism may work in one of the following ways:
1) In embodiments with accumulators in the wheel hub 31/on the opposite side of the piston weight 110a from the working fluid: As an individual spoke 32 enters the hot zone 30a of the wheel, the moving weight 110a is at its outermost position (away from the centre of the wheel/hub)—a lock may be arranged to hold the weight 110a in place, allowing the DCM (or other working fluid) to build up pressure within the heat exchanger 34 and DCM chambers for a portion of the rotation—this pressure may then be released at once, by releasing the lock (e.g. automatically once the pressure reaches a threshold level), to push the weight 110a towards the centre of the wheel/towards the hub as and when required as the wheel rotates the spoke towards the cooling section. Likewise, once the weight 110a is at the innermost position and the spoke is cooling, one or more pneumatic chambers of the pneumatic accumulator then become pressurised and, once cooling of the heat exchangers 34 has removed the DCM pressure on the piston, the accumulator locking mechanism may be triggered to release, pushing the weight back to the outermost position. The locking mechanism(s), where present, may therefore be purely mechanical and triggered automatically by pressure changes.
2) In embodiments with or without accumulators: supporting beams or rods 37 along which the piston weight 110a slides may be arranged to provide a locking mechanism. In particular, opposing ridged grooves 37a, 37b may be provided on moveable rods. The moveable rods may be the supporting beams 37, or may be a component of a multi-part supporting beam 37. The ridged grooves may be shaped and positioned to allow the weight 110a to travel only one way along the supporting rods 37; preventing the weight 110a from returning (much like how a zip-tie works). Once the weight 110a has travelled to its extreme position (i.e. innermost or outermost position), the rod will move (e.g. rotating, or retracting one set of ridged grooves within the support beam and extending another) to allow the reverse of the same mechanism to take effect. The weight 110a is therefore constrained to travel in only a first radial direction until the mechanism is switched, at the far end of the weight's range of travel. FIGS. 12a and 12b illustrate this “locking slide”—this can be thought of as a one-way locking mechanism which works by allowing movement in one direction while preventing the movement in the opposite direction, and being actuated to reverse which direction of movement is allowed. The mechanism is fully mechanical (not requiring electrical power for actuation, although a powered over-ride of the locking mechanism may be provided in some embodiments). FIG. 12 provides an example with two guide poles 37 per spoke 32, in which the ridges 37a, 37b shown protrude from, or contract within, the guiding poles 37, with movement between the two positions being triggered by the weight 110a hitting a lever at each extreme of its movement. FIG. 12A illustrates upward movement of the weight 110a, with the ridges 37a oriented so as to allow smooth upward movement but to catch any downward movement (it will be appreciated that a contact surface within the weight 110a may be shaped accordingly, as in a zip-tie). FIG. 12B illustrates downward movement of the weight 110a, with the ridges 37b oriented so as to allow smooth downward movement but to catch any upward movement. In the figures shown, the ridges 37a designed to prevent downward movement appear on the right-hand side of each support pole 37, and the ridges 37b designed to prevent upward movement appear on the left-hand side of each support pole 37. It will be appreciated that this may be reversed, or that the grooves may be on inner sides and outer sides rather than right sides or left sides, for example, in other embodiments. The locking mechanism(s), where present, may therefore be purely mechanical and triggered automatically by contact of the weight 110a with a leaver or other actuator. This kind of mechanism may facilitate smoother overall operation should there be fluctuations in the heating or cooling applied. In particular, whilst the weight 110a is intended to be travelling upwards (FIG. 12A), the locking mechanism 37a prevents downward slippage should pressure from below decrease/pressure from above increase. Likewise, whilst the weight 110a is intended to be travelling downwards (FIG. 12B), the locking mechanism 37b prevents upward slippage should pressure from above decrease/pressure from below increase.

The skilled person would appreciate that there are many mechanical locking mechanisms that could be used with the system, with locks on the individual modules/spokes allowing pressure to be built and stored, then released on demand, so facilitating engine control.

FIG. 8 illustrates another example of a heat engine 800 using principles described herein. A heat exchanger 50 is provided, comprising a plurality of heat exchange/expansion chambers 56, 102 extending above a heat source, H. The heat source, H, is located below the heat exchanger 50 in the example shown, optionally within a spacing provided by a mount or frame of the heat exchanger 50. A heat source cavity under the heat exchanger 50 may therefore be provided, with the intention of providing an at least substantially constant heat in operation—a sustainable, low-heat fuel may be burned, or waste heat from another process introduced into that space. A source of cooling, C, is also provided, with a coolant (e.g. water) flowing through the heat exchanger 50 from an inlet, Cᵢₙ, to an outlet, Cₒᵤₜ. The flow of coolant, C, can be stopped and started, and may be controlled by one or more valves or pumps.

The working fluid 10 flows through the heat exchanger 50, being heated by the heat source, H, and cooled by the coolant, C, when the coolant is flowing. The working fluid 10 is DCM in the embodiment being described, although other fluids may be chosen in other embodiments. The working fluid 10 is enclosed within a series of pipes, including within the heat exchanger 50. The heat exchanger 50 is arranged such that the working fluid 10 lies between the coolant C and the heat source, H, in the examples being described. For example, one or more pipes containing the coolant, C, may lie above the expansion chambers/pipe portions 102 within the heat exchanger 50 containing the working fluid 10 (on the far side of the working fluid from the heat source), or concentric pipes may be used as described above with respect to FIGS. 5 and 6. The pipe portion, or interconnected pipe portions, containing the working fluid 10 may together be thought of as forming the first chamber 102 as described above.

In the embodiment shown, the heat source, H, is continually present, and the coolant flow works against the heating. In other embodiments, the heat source, H, may be removed, turned off, or shielded in the cooling part of the cycle, so varying heat input over time. However, it has been found through experimentation that the cooling effect of water, or another relatively high heat-capacity fluid, is sufficient to generate useful work even without adding the complexity of adjusting the heat source.

The heat engine 800 further comprises a hydraulic fluid 20. The hydraulic fluid is contained within a pipe portion which may be described as a second chamber 104, and which lies outside of the region of the heat exchanger 50, and between the heat exchanger 50 and a drivetrain 110. The heat engine 800 further comprises a separator 106. The separator 106 is designed to keep the working fluid 10 isolated from the hydraulic fluid 20, and can be thought of as dividing the first chamber 102 from the second chamber 104. The separator 106 may be positioned part way along a pipe, separating first and second portions of the pipe which thereby form the first and second chambers 102, 104.

In the apparatus shown in FIG. 8, the separator 106 is provided by a U-shaped portion of pipe filled with mercury. The mercury separator 106 is kept towards the bottom of the U-bend by gravity, and a sufficient volume of mercury is used/a sufficient length of the U-bend is filled with mercury that the working and hydraulic fluids 10, 20 are kept apart even as the working fluid 10 expands and contracts. It will be appreciated that pipe diameters and lengths, U-bend sizes and amounts of mercury (or another suitable separator fluid) may be selected as appropriate for a given apparatus, and generally scale with the maximum expected displacement or power output to some extent. The separator 106 transfers force from the working fluid 10 to the hydraulic fluid 20 as the working fluid 10 expands, and returns to the lowest position it can in the U-bend under gravity when the working fluid 10 contracts. The mercury separator 106 in the U-shaped tube therefore prevents the working fluid 10 from reaching the drivetrain 110 whilst still allowing the transfer of motive force to the drivetrain 110 via the hydraulic fluid 20. In more complex embodiments, the hydraulic fluid 20 may flow into an accumulator arranged to distribute the flow and energy accordingly rather than simply driving a single pump 110 as shown here. The working fluid 10 is therefore enclosed in specialised chambers 102 which are separated by a mercury-filled separator 106 from a hydraulic powertrain powered by the heat engine 800. This arrangement using a hydraulic fluid 20 may avoid corrosion, leakage of fluids, and damage to parts which may otherwise result from use of a corrosive working fluid 10 as described herein.

The hydraulic system is attached to a reciprocating positive displacement pump 110 in the embodiment being described. A piston-based or plunger-based pump 110 may be used in various embodiments. The heat pump 800 therefore provides pumping as its output, so having a simple drivetrain 110. Heat from the heat source, H, increases the pressure across the system (due to expansion of the working fluid 10) to move the piston 110. Once the piston 110 is at its maximum stroke, the cooling liquid (e.g. water), C, is passed through the inner tubes of the heat exchanger 50 to cause rapid cooling of the working fluid 10, and therefore a release of pressure, returning the pump 110 to its initial position. Repeated starting and stopping of the coolant flow, C, therefore provides a reciprocating action, with the piston 110 moving up and down (in the orientation shown).

Using apparatus like that shown in FIG. 8, a 100 kg weight was lifted by 1 meter by raising the temperature of the heat exchanger 50 to around 120° C. The heat exchanger 50 was then cooled by the application of a few sprays of water (using a mister rather than a stream of liquid, using only around 1-2 ml of water) to a temperature of around 90° C. In this demonstration, the working fluid 10 was DCM, and 35 ml of the working fluid 10 (in the liquid state) was used in the heat exchanger 50. A temperature change of only around 30-40° C. was easily obtained within a few seconds of commencing heating, and was found to be sufficient to raise 100 kg by 1 m. In further experimentation, the 100 kg weight was lifted by 1 meter using 33 ml of working fluid with a heat difference of 46° C., and the same weight was lifted by 1 m using 23 ml of working fluid and a temperature difference of 50° C. In addition, a 30 kg weight was lifted by 0.5 m using 14 ml of working fluid 10 and a similar temperature difference.

It will be appreciated that the operation and output described with respect to FIG. 8 can be compared to the operation and output of the piston and heat exchanger system of any given spoke 32 of the wheel 300 of various embodiments, and may be scaled with wheel size. For example, a piston 110a may have a weight 110a, 111a with a mass of around 20 to 300 kg for each metre of radius length, and optionally 50 to 150 kg for each metre of radius length, for example. The weight may be provided by material selection for all or part of the piston's head and/or rod, or may be a dedicated component of the piston 110a. The mass of the other components of the piston 110a may be much smaller, for example around 1 kg for each metre of piston length (e.g. for components including a piston shaft, which may be made of metal). A piston rod area of 1.3 cm² was used for a steel piston rod in the example described above, and found to give more than sufficient mechanical strength. It will be appreciated that dimensions may be adjusted as appropriate depending on apparatus size, materials, piston weight, and expected working pressure, among other variables. This piston rod forms the piston head 111b against which the expanding working fluid 10 pushes, and is generally much smaller than the weight 111a. The cross-sectional area of the piston rod is directly proportional to the force being applied by the expanding working fluid 10 (pressure×area=force). The smaller the area of the piston head, the larger the force the working fluid 10 is therefore able to produce, and vice versa. This balances with the tensile strength of the piston rod, which needs to be strong enough to withstand the weight without buckling or bending. The use of relatively strong metals—including most common steels—allows for a relatively small piston head area to be used. In some embodiments, such as that shown in FIG. 11, the piston rod may narrow behind the head 111b, and it will be appreciated that the narrower part of the rod must also have sufficient mechanical strength to resist bending. In other embodiment, the piston rod may have a constant width equal to the piston head width. The piston head size may therefore be selected as appropriate for a given output, bearing in mind material and structural limitations to ensure the apparatus 300 is not damaged by internal forces/pressures.

A piston 110a may have a working fluid volume of 0.2-2 ml for each kg of the weight 110a, 111a. Alternatively, this may be looked at as using a mass of 0.5-5 kg for each ml of working fluid 10. It will be appreciated that the amount of mass lifted and the lift distance will vary depending on the temperature and temperature change of the working fluid 10 and the readiness of the heat transfer. With the same working fluid 10 (same substance, same volume), a larger weight (within structural limits of e.g. the piston chamber's resistance to internal pressure) can be lifted through the same distance given an appropriate temperature change. For larger wheels 300, the volume/mass of working fluid 10 (e.g. DCM) used may be scaled in proportion to wheel size (it will be appreciated that operating temperature range must be considered when assessing working fluid volume).

In various embodiments, the apparatus 300 is a pressurised system, with pneumatic chambers pre-pressurised to above atmospheric pressure. In particular, the hydraulic fluid and the working fluid (e.g. DCM) may both be pressurised to significantly above atmospheric pressure even before any heat is applied (beyond ambient/room temperature), and air, or any other fluid, in the spoke's pneumatic chambers may also be pressurise above ambient pressure. It will be appreciated that the pressure of the hydraulic fluid 20 is generally the same as the pressure of the working fluid 10, as the hydraulic fluid simply acts just as a non-compressible medium to transfer the force/pressure. The hydraulic pressure may be adjusted on manufacturing the apparatus, and may be further adjusted in use of the apparatus for example using one or more locks or valves (e.g. pressure release valves) to adjust the pressure. It will be appreciated that changing the temperature will also lead to a change in pressure, but that tailoring of pressure separately from temperature may be desirable in some implementations. For example, the working fluid 10 and intervening hydraulic fluid 20 may be pressurised to 10 kPa above ambient whereas the pneumatic chambers may be pressurised to only 100-200 Pa (0.1 to 0.2 kPa) above ambient. The piston head size may be adjusted proportionally between the two fluids with which it interacts, having a larger surface area of interaction with the fluid (e.g. air) in the pneumatic chamber on one side than with the working/hydraulic fluid 10, 20 on the other (for clarification, the piston head generally does not change in size in any way once in the system, but a given piston head can have ends of different cross-sectional areas—an appropriate piston head can be selected during the assembly of the engine, to cater to the different weight/energy outputs.). The working fluid 10 is selected to be able to withstand higher pressures, so a smaller area can be used for the same force to be transferred.

FIG. 9 illustrates a method 900 of various embodiments, which can be used with a gravity heat engine 300 as described above and illustrated in FIGS. 3 and 4. The method 900 comprises orienting 902 the wheel 30 in a vertical plane. This step may comprise mounting the wheel 30 on an axle and securing the axle to a frame, wall, or other support 36 such that the axle is in a horizontal plane. In some embodiments, with relatively low power outputs (e.g. for domestic use), the wheel 30 may be provided with a support or frame 36 and may be self-supporting and portable. In other embodiments, especially with higher power outputs (e.g. for industrial use), the wheel 30 may be mounted on a wall or other frame, or in a dedicated building.

The method 900 further comprises connecting 904 an axle, or other component, of the wheel 30 of the heat engine 300 arranged to rotate in use, to a generator 120 or mechanical drivetrain 110. In embodiments in which the engine 300 is to be used to generate electricity, a generator 120 is connected 904 and the generator 120 is arranged to use the wheel's rotation to generate electricity. In embodiments in which the engine 300 is to be used to do mechanical work directly, a drivetrain 110 such as a pump or other moveable parts, e.g. machinery, may be connected in place of a generator. In some embodiments, the engine 300 may be used to generate electricity and to perform mechanical work directly—there may be multiple attachments to the wheel 30. It will be appreciated that in some embodiments the generator 120 and/or drivetrain 110 may be connected 904 before the location of the wheel 30 is set 902—the two listed method steps 902, 904 may therefore be performed in either order depending on specifics of the apparatus. The method 900 further comprises exposing 906 one portion of the wheel 30 to a heat source, H. The portion of the wheel 30 to be heated may be described as one side, or one half-disk, of the wheel, as indicated by the lighter and darker grey regions in FIGS. 3 and 4. A hypothetical vertical dividing line passing through the wheel's axis separates the two portions this may also be thought of as a hypothetical vertical plane extending along the wheel's axis separating the two portions. For a given spoke 32, the heating of that spoke 32 therefore commences when, or just after, that spoke reaches a vertical position at the bottom of the wheel 30, and continues until, or to just before, that spoke 32 reaches a vertical position at the top of the wheel 30, in the example pictured. In other embodiments, that may be reversed, with the heating of a given spoke 32 commencing when, or just after, that spoke reaches a vertical position at the top of the wheel 30, and continuing until, or to just before, that spoke 32 reaches a vertical position at the bottom of the wheel 30. The working fluid 10 is selected to expand and contract rapidly in response to heating and cooling, such that the weighted piston 110a is moved to its extreme position promptly on entering the heated region, and maintained in that position until it leaves the heated region, and likewise in the cooled region.

This exposure to a heat source, H, drives rotation of the wheel 30 by causing the working fluid 10 in the radial spokes 32 located within that portion of the wheel to expand, moving the weighted pistons 110a and so driving rotation of the wheel 30 under gravity. The motion of the wheel 30 rotates radial spokes into, through, and out of the heated region, so the portion of the wheel being heated/which spokes are heated changes with time as the wheel 30 rotates. The engine 300 therefore generates torque/moment using the response of the working fluid 10 to heat, in conjunction with gravity, and is therefore termed a gravity-heat engine 300. If the working fluid 10 is located in an axial region of the wheel 30, i.e. near the hub 31, exposing 906 one portion of the wheel to a heat source causes the working fluid 10 in the radial spokes 32 located within that portion to expand, so pushing the weighted pistons outwardly. As weights near the top of the wheel 30 move outward, rotation of the wheel is driven under gravity due to the net moment. If the working fluid 10 is instead located in a region of the wheel 30 closer to the wheel's circumference, exposing 906 one portion of the wheel to a heat source causes the working fluid 110 in the radial spokes 32 located within that portion to expand, so pushing the weighted pistons inwardly, towards the wheel's axis. As weights near the bottom of the wheel 30 move inward on entering a heated region, rotation of the wheel is driven under gravity due to the net moment.

The method 900 of various embodiments further comprises causing a coolant (e.g. water) to flow through or over the unheated portion of the wheel so as to hasten cooling and contraction of the working fluid 110. In the embodiments described herein, the coolant, C, is arranged to flow through a passageway 56 within each radial spoke, the passageway 56 passing within an expansion chamber 102 of the working fluid so as to improve heat transfer away from the working fluid 10, so hastening its cooling and corresponding contraction. The heat source, H, may be waste heat from an industrial process, or may be from burning a renewable resource such as plant matter/wood or animal waste.

It will be appreciated that the particular embodiments described in detail herein are provided by way of example only, and are not intended to limit the scope of the claims. Many possible variations will be apparent to the skilled person on reading this disclosure.

1. A gravity-heat engine comprising:
a plurality of radial spokes forming a wheel, each spoke comprising a weighted piston, a head of the piston being slidingly received within a piston chamber; and
a working fluid arranged to expand when heated; and
a hydraulic fluid located within the piston chamber and separated from the working fluid,
and wherein the gravity-heat engine is arranged such that the hydraulic fluid is moved by the expansion of the separate working fluid so as to cause the weighted piston to move along the radial spoke in a first direction in response to heating of the working fluid.

2. The gravity-heat engine of claim 1, wherein the working fluid is located within the piston chamber, and is arranged to cause the piston to move along the radial spoke in the first direction when the working fluid expands in response to being heated.

3. (canceled)

4. The gravity-heat engine of claim 1 wherein the working fluid has a boiling point of no more than 60° C. at standard pressure and a relative density with respect to water greater than 1.

5. The gravity-heat engine of claim 1, wherein the working fluid is contained within an expansion chamber comprising a separator arranged to separate the working fluid from the hydraulic fluid.

6. The gravity-heat engine of claim 1, wherein the piston chamber is arranged such that the weighted piston moves inwardly along the radial spoke in response to heating of the working fluid.

7. The gravity-heat engine of claim 1, preceding claim, wherein each spoke further comprises a heat exchanger comprising a broad surface providing a relatively large area for heat exchange as compared to a stem of the spoke, the broad surface forming a portion of an edge of the wheel and at least one passageway arranged to have the working fluid pass therethrough in use.

8. (canceled)

9. The gravity-heat engine of claim 1, further comprising a coolant reservoir located above one side of the wheel and arranged to provide a flow of coolant to cool one side of the wheel.

10. The gravity-heat engine of claim 1, wherein each spoke further comprises a pneumatic accumulator arranged to store pressure and to work against the piston so as to move the piston in a second radial direction opposite to the first direction when the working fluid contracts in response to being cooled.

11. The gravity-heat engine of claim 1, wherein the working fluid is contained within at least one expansion chamber, the at least one expansion chamber comprising a channel therewithin arranged to allow a coolant to pass therethrough whilst remaining isolated from the working fluid.

12. The gravity-heat engine of claim 1, comprising a hydraulic fluid arranged to be moved by the expansion of the working fluid and to move a drivetrain of the gravity-heat engine, and wherein the working fluid is separated from the hydraulic fluid by a separator, the separator being arranged to prevent the working fluid from reaching the drivetrain but to allow pressure to be applied to the hydraulic fluid by the working fluid so as to drive the drivetrain.

13-14. (canceled)

15. The gravity-heat engine of claim 1, wherein the working fluid is at least 90% dichloromethane by volume.

16. The gravity-heat engine of claim 1, wherein each piston is independent of every other piston.

17. The gravity-heat engine of claim 1, wherein each piston can move along a distance of no more than 90% of the radial extent of its spoke.

18. The gravity-heat engine of claim 1, wherein each weighted piston comprises a weight of a relative density with respect to water of at least the weight being arranged to move when the piston head moves.

19. The gravity-heat engine of claim 18, wherein a smallest dimension of the weight is parallel to the radius of the wheel such that the mass of the weight is radially localised.

20. The gravity-heat engine of claim 1, wherein the wheel comprises a hub from which each spoke extends, the hub defining an innermost position that the head of each piston can reach.

21. The gravity-heat engine of claim 20, wherein the hub comprises an independent locking mechanism actuator for each spoke, the locking mechanism actuator being arranged to trigger at least one of locking and release of a locking mechanism arranged to control movement of the piston.

22. A method of operating a gravity-heat engine as described in claim 1, the method comprising:
orienting the wheel in a vertical plane; and
exposing one portion of the wheel to a heat source so as to drive rotation of the wheel by causing the working fluid in the radial spokes located within that portion to expand, moving the hydraulic fluid, and thereby moving the weighted pistons and so driving rotation of the wheel under gravity.

23. The method of claim 22, further comprising causing a coolant to flow so as to hasten cooling and contraction of the working fluid of the radial spokes located within the unheated portion of the wheel.

24. The method of claim 23, wherein the coolant is water.

25. (canceled)
